(19) United States
(12) Patent Application Publication
(10) Pub. No.: US 2006/0230357 A1
(43) Pub. Date: Oct. 12, 2006

(54) Software and Method for Internally Organizing Marketing Tasks and Related Information Within a Business Entity

(76) Inventor: Cher Esque, Columbus, OH (US)

Correspondence Address: PORTER WRIGHT MORRIS & ARTHUR, LLP;INTELLECTUAL PROPERTY GROUP, 41 SOUTH HIGH STREET, 28TH FLOOR, COLUMBUS, OH, 43215, US

(21) Appl. No.: 11/426,197

(22) Filed: Jun. 23, 2006

Related U.S. Application Data
(63) Continuation-in-part of application No. 09/687,846, filed on Oct. 13, 2000, now abandoned.

(51) Int. Cl. G06F 17/00

(52) U.S. Cl. 715/777; 715/780

(57) ABSTRACT

A software product generates a main navigational window viewable on a computer display which has a plurality of links including a marketed entities link, an avenues link, a contacts link, and an events link. The marketed entities link opens a marketed entities window having data fields for contact data relating to particular marketed entities. The avenues link opens an avenue window having data fields for contact data relating to avenues of marketing used for the marketed entities. The contacts link opens a contact window having data fields for contact data relating to particular individuals. The events link opens an event window having data fields for contact data relating to events for the marketed entities. A to-do list window displays stored actions associated with a particular person within the business entity and has links to event windows related to the stored actions and to contact windows related to the stored actions.

### CROSS-REFERENCE TO RELATED APPLICATIONS

This application is a Continuation-In-Part (CIP) of U.S. patent application Ser. No. 09/687,846 titled “Software and Method for Marketing Artists” and filed on Oct. 13, 2000, the disclosure of which is expressly incorporated herein in its entirety by reference.

### STATEMENT REGARDING FEDERALLY SPONSORED RESEARCH

Not Applicable

### REFERENCE TO MICROFICHE APPENDIX

Not Applicable

### FIELD OF THE INVENTION

The present invention generally relates to software and methods for organizing information and, more particularly, to software and methods for internally organizing marketing tasks and related information within a business entity. The related information preferably includes information relating to the marketed entity, marketing avenues through which the entity is marketed, marketing events at which the entity is marketed, and individuals participating in and responsible for the marketed entity, avenues and events within the business entity.

### BACKGROUND OF THE INVENTION

Since at least the early nineties, the recoding industry has been in a constant state of flux with massive layoffs at various corporate headquarters. These massive layoffs were directly related to the ever increasing operational costs in the form of human expenditure.

Business rules in use within the recording industry make it difficult to cost-effectively market new and upcoming artists and their associated products. Large conglomerate type music corporations can't financially afford the risk associated with developing smaller relatively unknown “baby acts.” Baby acts require time, attention and grass roots marketing. Grass roots marketing is labor intensive and difficult to manage because of the geographic and demographic range of marketing. As a result, marketing is often contracted out to independent promoters who charge the recording companies thousands of dollars with no guarantee of a return.

A record company has a large quantity of information and data to be processed in the form of tasks (or pieces of work) within a time frame (such as by minutes, hours, days, weeks, months, quarters, or years). A major component to developing a successful recording artist is the internal and timely management of these tasks. These tasks distributed internally to employees within the company are directly related to the record company's operational costs.

There are many electronic calendar and contact programs commercially available on the market in which you can store contact information and schedule events. These programs are designed to be general purpose databases. While these programs may adequately store information, they are very inefficient to use in connection with internally organizing the management of tasks related to marketing or promotional campaigns in a specific industry. They lack the underlying structural logic to internally organize a business entity and the management of tasks related to the business entity, and its marketing or promotional campaigns within a specific industry. Accordingly, there is a need in the art for improved software and methods for internally organizing marketing tasks and related information in order to reduce operating costs in the form of “human expenditure” and to increase “human capital.”

### SUMMARY OF THE INVENTION

The present invention provides improved software and methods for internally organizing marketing tasks and related information within a business entity, which overcome at least some of the above-noted problems of the related art. According to the present invention, a software product for internally organizing marketing tasks and related information within a business entity comprises a software program that generates a main navigational window viewable on a computer display. The main navigational window has a plurality of links including a marketed entities link, an avenues link, a contacts link, and an events link. The marketed entities link opens a marketed entities window having data fields for entering and viewing contact data relating to particular individuals of particular marketed entities. The avenues link opens an avenue window having data fields for entering and viewing contact data relating to particular individuals at different avenues of marketing used for marketing the particular marketed entities. The contacts link opens a contact window having data fields for entering and viewing contact data relating to a particular individual. The events link opens an event window having data fields for entering and viewing event data and contact data relating to particular individuals associated with particular events used for marketing the particular marketed entities. A to-do list window displays stored actions associated with a particular person within the business entity and has links to particular contact and event windows.

According to another aspect of the present invention, a method for internally organizing marketing tasks and related information within a business entity comprising the steps of generating a main navigational window viewable on a computer display that has a plurality of links and generating additional windows viewable on the computer display upon activation of the plurality of links. The plurality of links include a marketed entities link, an avenues link, a contacts link, and an events link. A marketed entities window having data fields for entering and viewing contact data relating to particular individuals of particular marketed entities is opened upon activation of the marketed entities link. An avenue window having data fields for entering and viewing contact data relating to particular individuals at different avenues of marketing used for marketing the particular marketed entities is opened upon activation of the avenues link. A contact window having data fields for entering and viewing contact data relating to a particular individual is opened upon activation of the contacts link. An event window having data fields for entering and viewing contact data relating to particular individuals associated with particular events used for marketing the particular marketed entities is opened upon activation of the events link. A to-do list window is displayed having stored actions associated with a particular person within the business entity and links to particular event windows related to the stored actions and to particular contact windows related to the stored actions.

According to yet another aspect of the present invention, a method for internally organizing marketing tasks and related information within a business entity comprises the steps of: (a) determining the business rules of the business entity; (b) creating a software product with functions and procedures that are based on the business rules. The software product can display a to-do list having stored actions associated with a particular person within the business entity and links to contact data for particular individuals related to the stored actions.

From the foregoing disclosure and the following more detailed description of various preferred embodiments it will be apparent to those skilled in the art that the present invention provides a significant advance in the technology of software and methods for internally organizing marketing tasks and related information. Particularly significant in this regard is the potential the invention affords for providing a high quality, reliable, efficient, and easy to use software and method that can be utilized in all industries. Additional features and advantages of various preferred embodiments will be better understood in view of the detailed description provided below.

### BRIEF DESCRIPTION OF THE DRAWINGS

These and further features of the present invention will be apparent with reference to the following description and drawings, wherein:

FIG. 1 is a view of a main navigational window for software according to the present invention;

FIG. 2 is a view of an “Artists” tab of an “Artists Organization” window obtained through the “Artist” button of the main navigational window of FIG. 1;

FIG. 3 is a view of a “Members” tab of the “Artists Organization” window of FIG. 2;

FIG. 4 is a view of a “Products” tab of the “Artists Organization” window of FIG. 2;

FIG. 5 is a view of a “Biography” tab of the “Artists Organization” window of FIG. 2;

FIG. 6 is a view of a “Tour Dates” tab of the “Artists Organization” window of FIG. 2;

FIG. 7 is a view of an “Itinerary” tab of the “Artists Organization” window of FIG. 2;

FIG. 8 is a view of a “Notes” tab of the “Artists Organization” window of FIG. 2;

FIG. 9 is a view of an “Affiliations” tab of the “Artists Organization” window of FIG. 2;

FIG. 10 is a view of an “Avenues” window obtained through the “Avenues” button of the main navigational window of FIG. 1, wherein radio data is displayed;

FIG. 11 is a view of a “Promotions” tab of a “Radio Profile” window obtained through the “Profile” button of the “Avenues” window of FIG. 10;

FIG. 12 is a view of a “Programs” tab of the “Radio Profile” window of FIG. 11;

FIG. 13 is a view of a “Studio Address” tab of the “Radio Profile” window of FIG. 11;

FIG. 14 is a view of an “Avenues” window similar to FIG. 10 but wherein retail data is displayed;

FIG. 15 is a view of a “Promotions” tab of a “Retail Profile” window obtained through the “Profile” button of the “Avenues” window of FIG. 14;

FIG. 16 is a view of an “Avenues” window similar to FIGS. 10 and 14 but wherein media data for a newspaper is displayed;

FIG. 17 is a view of a “Promotions” tab of a “Newspapers and Magazine Profile” window obtained through the “Profile” button of the “Avenues” window of FIG. 14;

FIG. 18 is a view of an “Avenues” window similar to FIGS. 10, 14, and 16 but wherein media data for a TV station is displayed;

FIG. 19 is a view of a “Promotions” tab of a “TV Profile” window obtained through the “Profile” button of the “Avenues” window of FIG. 18;

FIG. 20 is a view of a “Programs” tab of the “TV Profile” window of FIG. 19;

FIG. 21 is a view of a “Studio Address” tab of the “TV Profile” window of FIG. 19;

FIG. 22 is a view of an “Avenues” window similar to FIGS. 10, 14, 16, and 18 but wherein venue data is displayed;

FIG. 23 is a view of a “Promotions” tab of a “Venue Profile” window obtained through the “Profile” button of the “Avenues” window of FIG. 22;

FIG. 24 is a view of a “Contacts” tab of a “Contacts” window obtained through the “Contact” button of the main navigational window of FIG. 1 or the “Contact” button of the “Avenues” windows of FIGS. 10, 14, 16, 18 and 22;

FIG. 25 is a view of a “Follow-up” tab of the “Contacts” window of FIG. 24;

FIG. 26 is a view of an “Events” tab of the “Contacts” window of FIG. 24;

FIG. 27 is a view of an “Events” window obtained through the “Events” button of the main navigational window of FIG. 1 or the “Schedule Event” button of the “Contacts” windows of FIG. 24;

FIG. 28 is a view of an “Artist Events” window obtained through the “View Calendar” button of the “Events” windows of FIG. 27;

FIG. 29 is a view of an “Employees” tab of an “Employees” window obtained through the “Employees” button of the main navigational window of FIG. 1;

FIG. 30 is a view of a “Submissions” tab of the “Employees” window of FIG. 29;

FIG. 31 is a view of a “Submissions” record of the “Submissions” window of FIG. 30;

FIG. 31A is a view of a “Activities” tab of the “Employees” window of FIG. 29;

FIG. 32 is a view of a “Calendar Choice” window obtained through the “Calendar” button of the main navigational window of FIG. 1;

FIG. 33 is a view of a “Calendar Of Events” window obtained through the “To Do List” button of the “Calendar Choice” window of FIG. 32;

FIG. 33A is a view of a “To Do List” window obtained through the “Search” button of the “Calendar of Events” window of FIG. 33;

FIG. 34 is a view of a “Calendar Of Events” window obtained through the “Artist Schedule” button of the “Calendar Choice” window of FIG. 32;

FIG. 35 is a view of an “Artist Events” window obtained through the “Search” button of the “Calendar of Events” window of FIG. 42;

FIG. 36 is a view of a “Calendar Of Events” window obtained through the “Contact History” button of the “Calendar Choice” window of FIG. 32;

FIG. 37 is a view of a “Search And Apply” window obtained through the “Search” button of the main navigational window of FIG. 1;

FIG. 38 is a view of an “Update Your Calendar History” window obtained through the “Update” button of the “Search And Apply” window of FIG. 37;

FIG. 39 is a view of a “Merges” window obtained through the “Merge” button of the “Update Your Calendar History” window of FIG. 38;

FIG. 40 is a view of a “Distributors” window obtained through the “Distributors” button of the “Artist Organization” window of FIG. 4;

FIG. 41 is a view of an “Archives” window obtained through the “Archives” button of the main navigational window of FIG. 1;

FIG. 42 is a view of an “Archives” window obtained through the “Retrieve” button of the “Archives” window of FIG. 40;

FIG. 43 is a view of a “Reports” window obtained through the “Reports” button of the main navigational window of FIG. 1;

FIG. 44 is a view of a “Web Sites” window obtained through the “Web Sites” button of the main navigational window of FIG. 1;

FIG. 45 is a diagrammatic flow chart showing a method according to the present invention; and

FIG. 46 is a diagrammatic view of the “To Do List” of FIGS. 32 to 35.

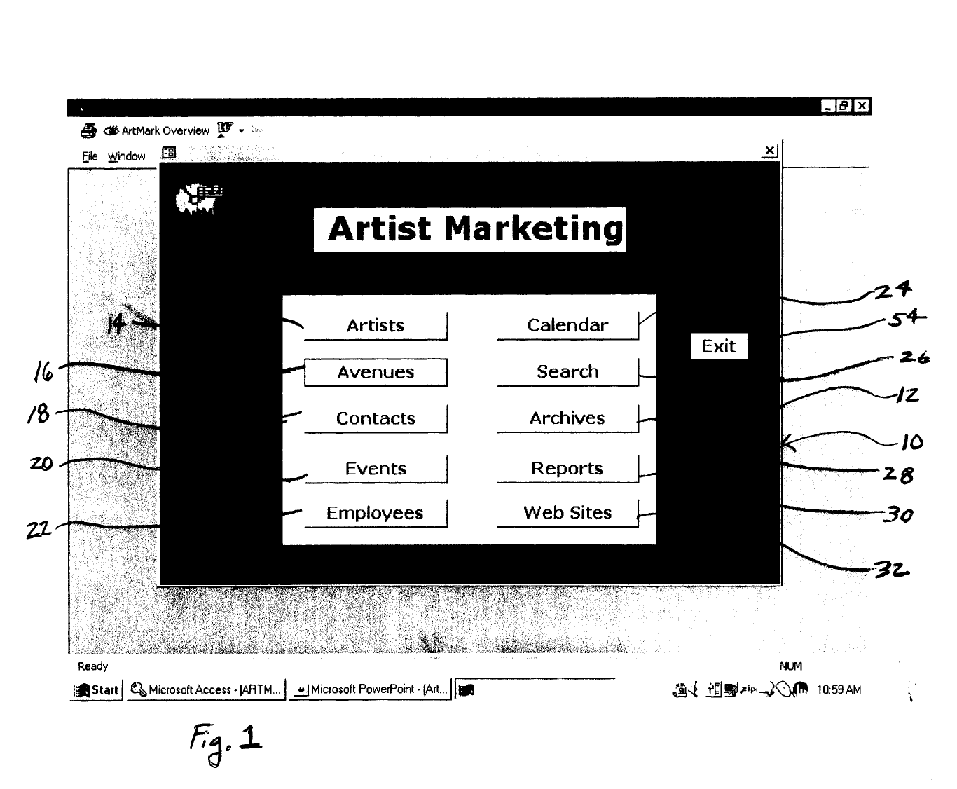

It should be understood that the appended drawings are not necessarily to scale, presenting a somewhat simplified representation of various preferred features illustrative of the basic principles of the invention. The specific design features of the software and method as disclosed herein, including, for example, specific dimensions, orientations, and shapes of the windows will be determined in part by the particular intended application and use environment. Certain features of the illustrated embodiments have been enlarged or distorted relative to others to facilitate visualization and clear understanding. In particular, thin features may be thickened, for example, for clarity or illustration. All references to direction and position, unless otherwise indicated, refer to the orientation of software illustrated in the drawings. In general, up or upward refers to an upward direction in of the plane of the paper in FIG. 1 and down or downward refers to a downward direction in the plane of the paper in FIG. 1.

### DETAILED DESCRIPTION OF CERTAIN PREFERRED EMBODIMENTS

It will be apparent to those skilled in the art, that is, to those who have knowledge or experience in this industry and/or area of technology, that many uses and design variations are possible for the improved software and method for internally organizing marketing tasks and related information within a business entity disclosed herein. The following detailed discussion of various alternative and preferred embodiments will illustrate the general principles of the invention with particular reference to a preferred embodiment for marketing and promoting musical artists such as, for example, vocalists, musicians, bands and the like. Other embodiments suitable for other marketed entities will be apparent to those skilled in the art given the benefit of this disclosure. For example, the marketed entities can be literary, visual and performing artists such as authors, painters, sculptors, dancers, theatrical actors, film and television actors, and the like, as well as various other products and services.

These particular terms are to have the following meanings as used within the specification and claims. The term “business entity” means person, organization, partnership or corporations. The term “business rules” means rules that describe the operations and constraints and that apply to the business entity in achieving its objectives. The term “contact” or “contact person” means a particular person or individual responsible for at least a portion of a task for marketing a particular marketed entity. The term “contact data” means information related to contacting or prior contacts with a particular individual. The term “marketed entity” means an individual, group, product or service that is marketed for the purpose of buying or selling. The term “task” or “action” means something that involves physical and/or mental effort as part of ones duties. The term “time table” means a list showing the minutes, hours, days, weeks, months, quarters and years at which particular events will occur and/or have occurred. The term “calendar of events” means a timetable of events relative to tasks for marketing a marketed entity. The term “avenues” means a choice or path in relation to marketing a marketed entity. The term “events” means something that happens in relation to marketing a marketed entity. The term “To Do List” or “Task List” means a list of tasks in relation to marketing a marketed entity. The term “human expenditure” means the use of physical or mental effort. The term “human capital” means leveraging the use of physical or mental effort. The term “stored” means placed in memory for later recall or use. The term “data fields” or “data entry fields” means a specific area in an electronic record allocated for a particular category of data, usually one data element such as a name. The term “employee” means a person performing a task for or on behalf of a business entity. The term “link” or “hyperlink” means a word, phrase or image that one can click on to jump to a new document or page or a new section within the current document or page. The term “marketing task” means a task related to marketing a marketed entity.

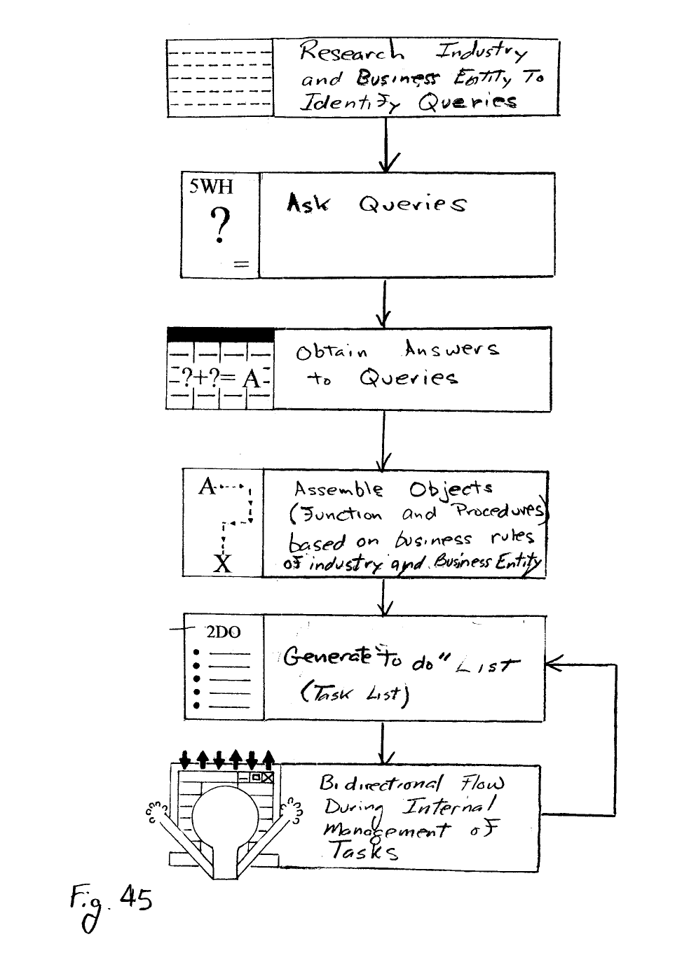

As best shown in FIG. 45, the present invention provides software and methods that addresses the need in the art for internally organizing a business entity's management of tasks and activities to reduce operating costs in the form of “human expenditure.” The illustrated method includes the first step of researching the particular industry and business entity in order to identify and develop appropriate queries or questions. The queries are developed using the “5WH” formula (short for Who, What, Where, Why, When, and How) and form the business rules. For example, when the business entity is a recording company and the marketed entity is an artist the queries include: (1) Who is the artist?; (2) What product is the artist releasing?; (3) Where is the artist to be interviewed?; (4) When is the artist to be interviewed?; (5) Why is the artist to be interviewed?; and (6) How is the artist to be interviewed?. The queries are constructed using the 5WH formula in order to identify specific business rules of a particular industry. The business rules break down the information into manageable internal and external tasks. The tasks are then programmed into the software through the construction of its underlying logic and objects.

The queries are asked to appropriate individuals within the business entity to define the business objectives. Once answers to the queries are obtained, objects that comprise the underlying logic of the software program are developed. The software program is preferably contained in one database container with the following objects: (1) tables; (2) queries; (3) forms; (4) controls; (5) functions; (6) procedures; and (7) reports. Tables determine what data fields will be stored. Queries provide the logical boundaries for the stored data in the tables. Forms provide visual boundaries and display the data stored in the queries. Controls provide navigation and choice on the forms. Functions provide parameters for the queries and automate form routines. Procedures provide directions for the forms to follow in order to accomplish a task. Reports extract and organize the data from the forms for printed display.

Once the software program is developed for the specific business entity, employees can enter information relating to marketing and promotional campaigns. With relevant information entered, a specific employee can be selected who is linked to a to-do list or task list that identifies all marketing items that are associated with that employee, for a selected period of time. The task list also includes links to related contacts and information so that the employee can easily view information related to the items on the task list. The related contacts enable the employee to quickly identify a particular contact person and their associated data. Thus, there is a bi-directional flow of information as the employee uses the software program in the management of marketing tasks.

The above described method can be used to develop software products for internally organizing marketing tasks within a wide variety of different industries for use with a wide variety of marketed entities. An example of a software product developed using this method is a software product for use within a recording company, in the music industry, where the marketed entities are recording artists and associated products.

Referring now to the drawings, FIG. 1 shows a main switchboard or navigational window 12 of a database program 10 for marketing or promoting artists according to a preferred embodiment of the present invention. The database program 10 is adapted to store and retrieve information on a computer or network of computers. The window 12 and subsequent windows are shown as viewed on a display of a computer. The term “Window” in this specification and the claims includes the windows created in a windowing computer operating system such as, for example WINDOWS 98 of the Microsoft Corporation or MACINTOSH O.S. 7.0 of Apple Computer, Inc. and also includes other types of screens and displays available in other operating environments.

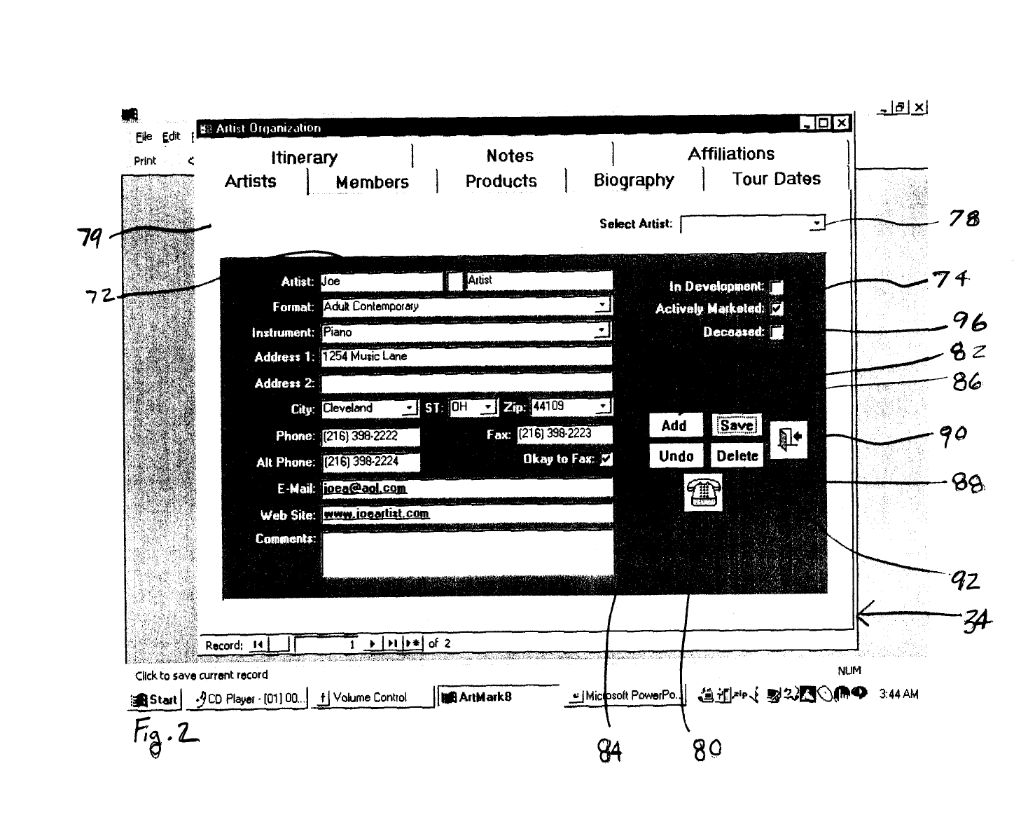

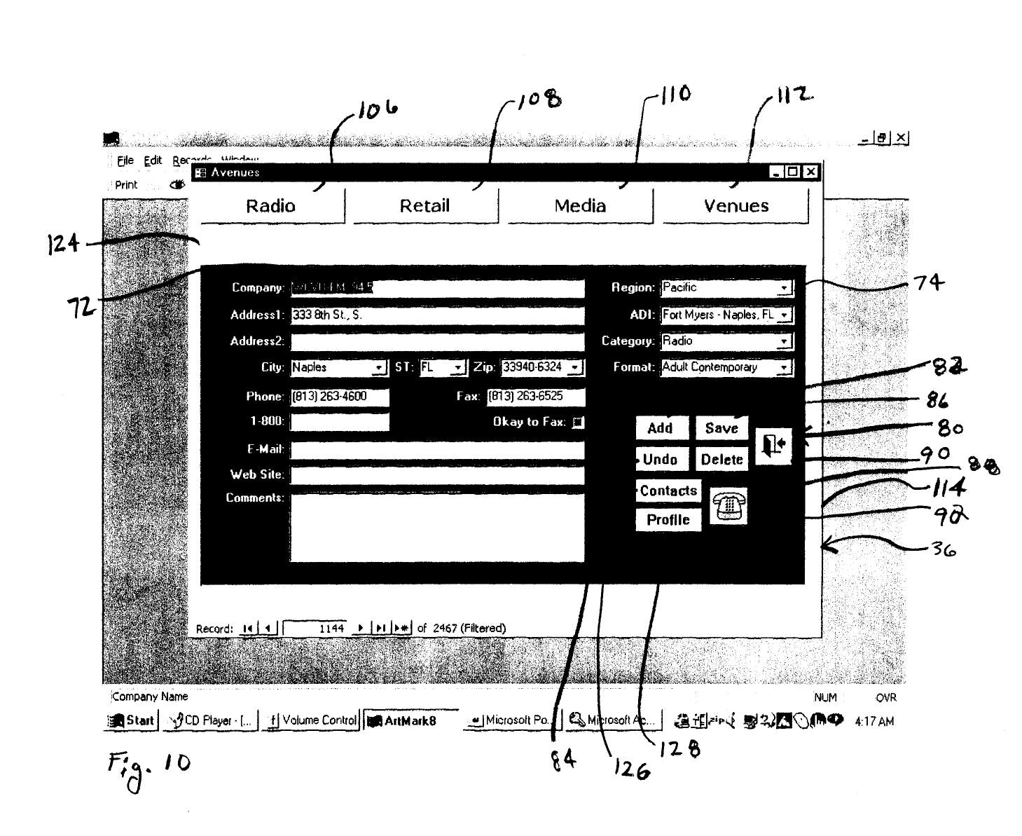

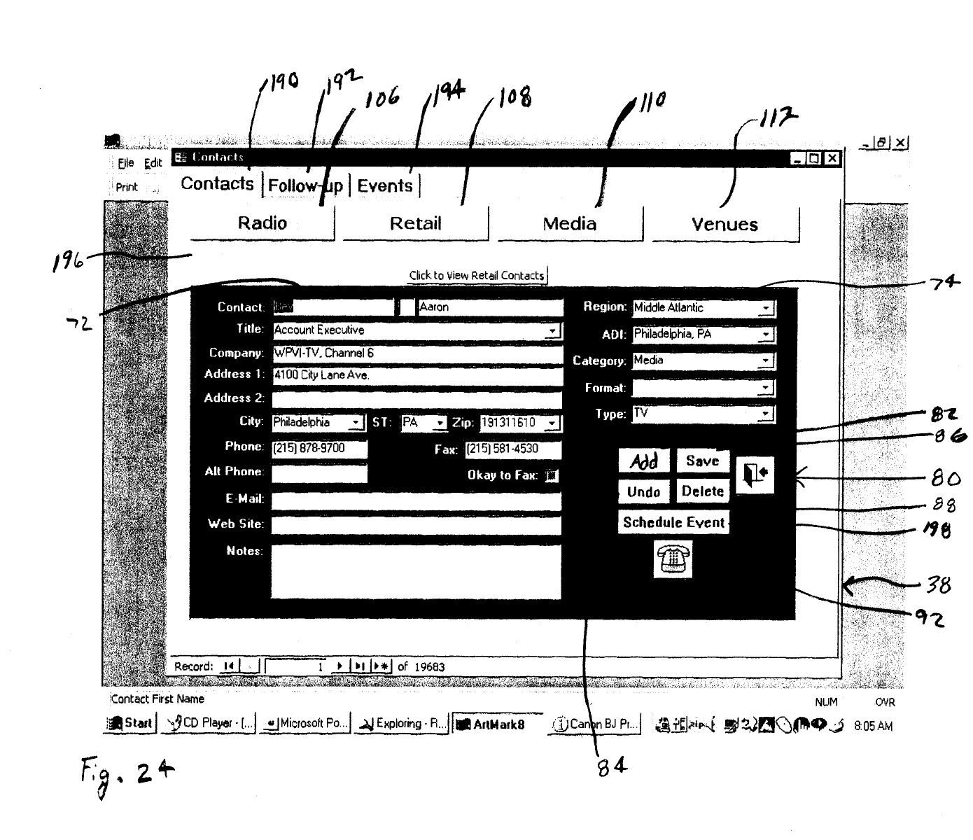

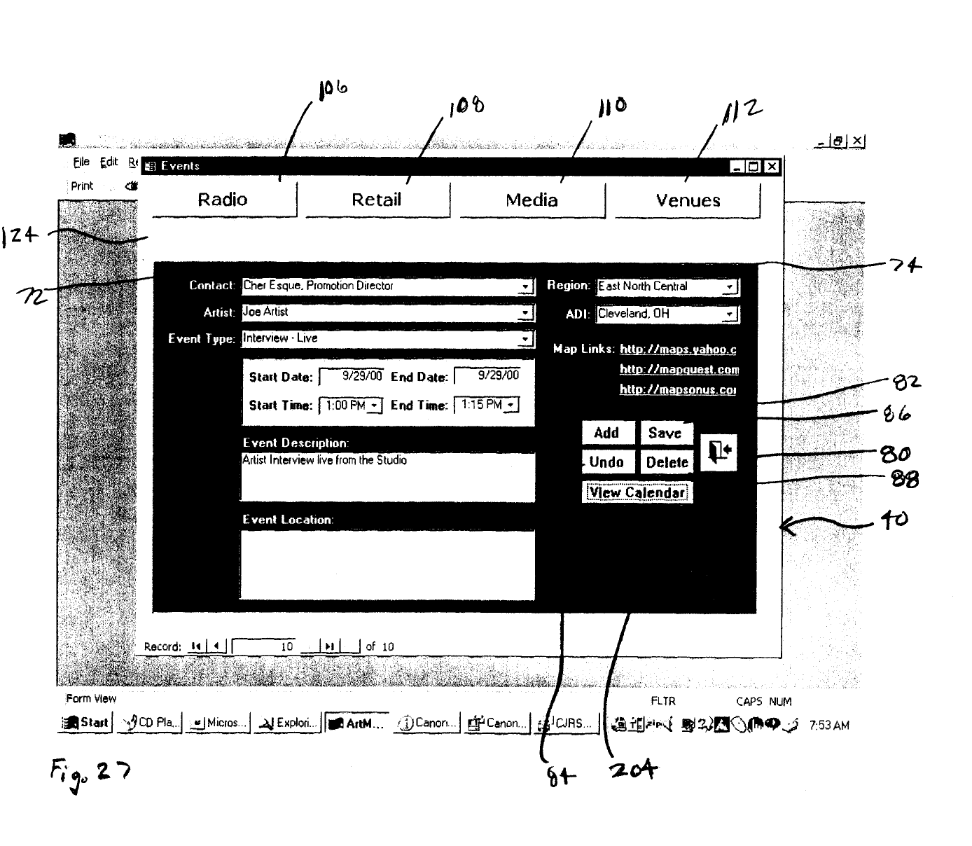

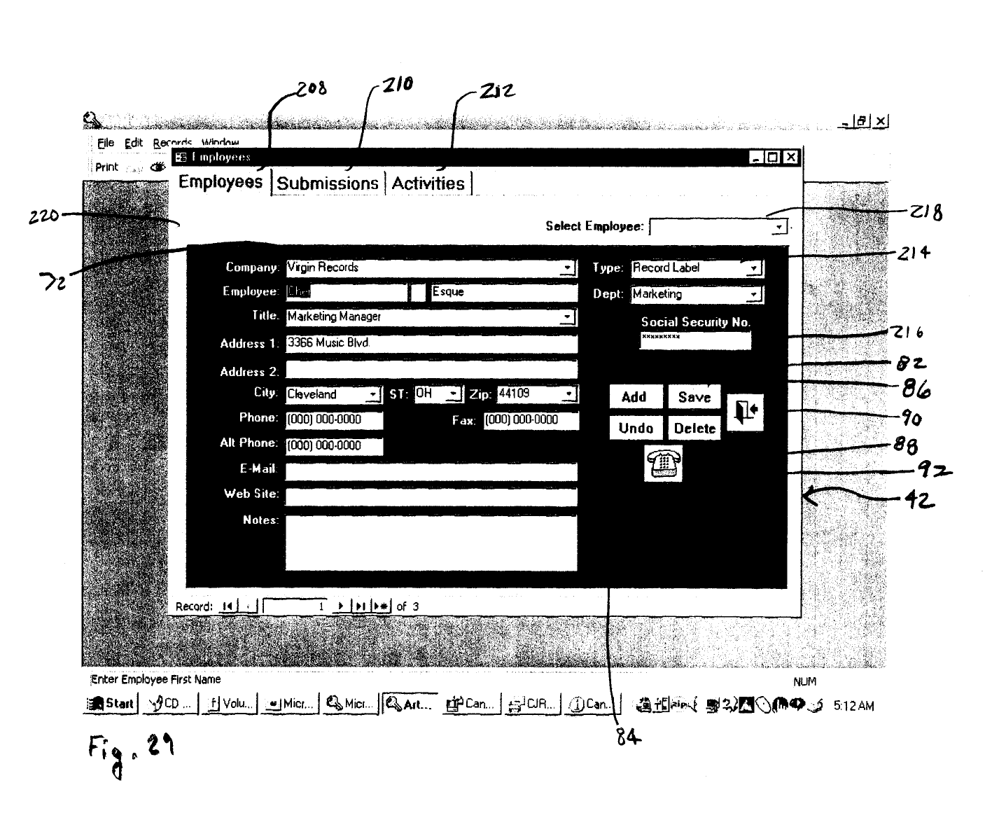

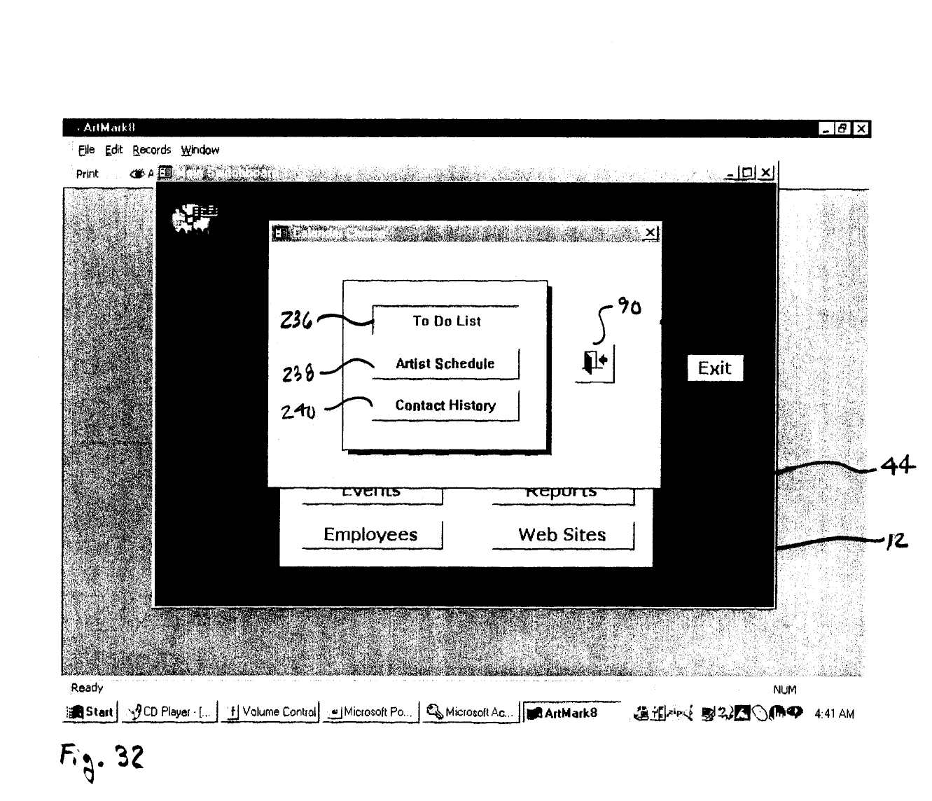

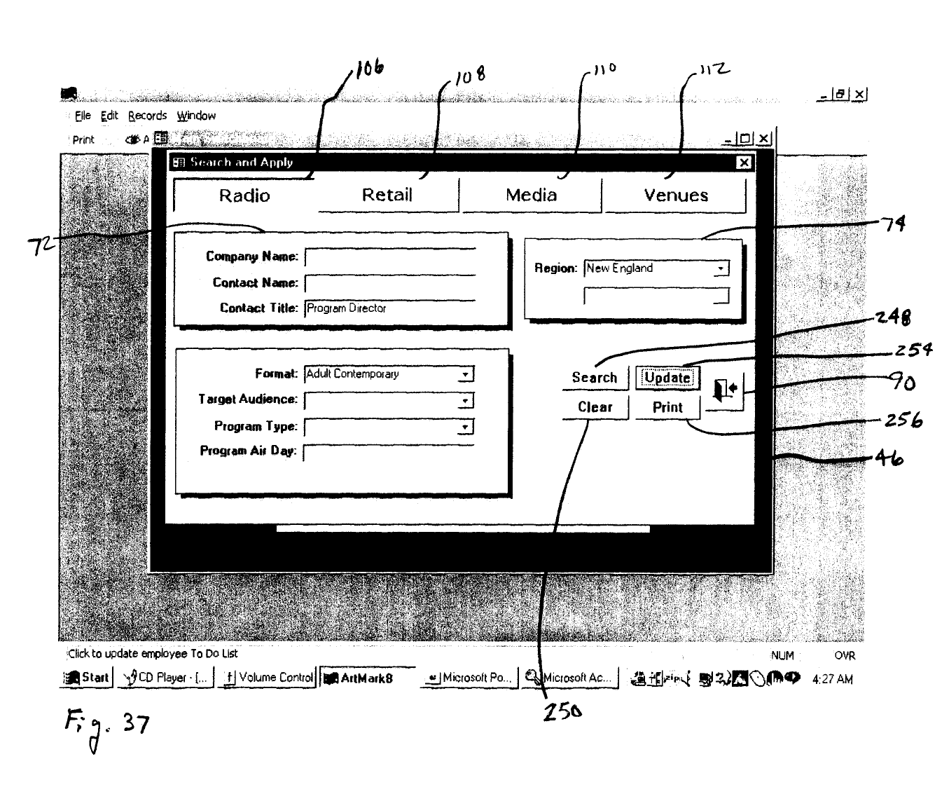

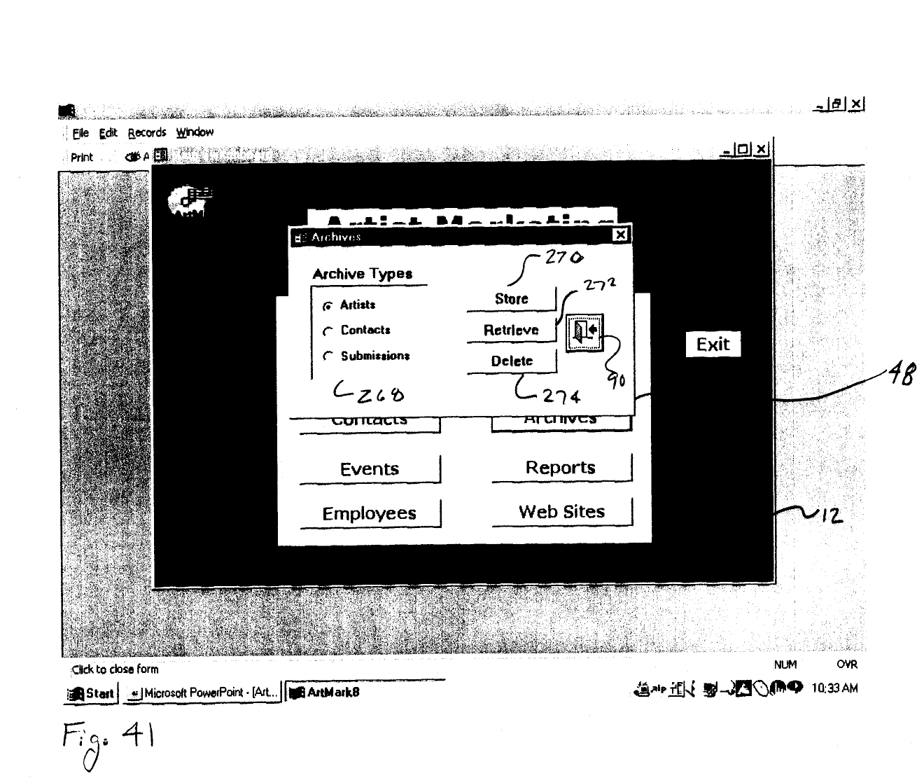

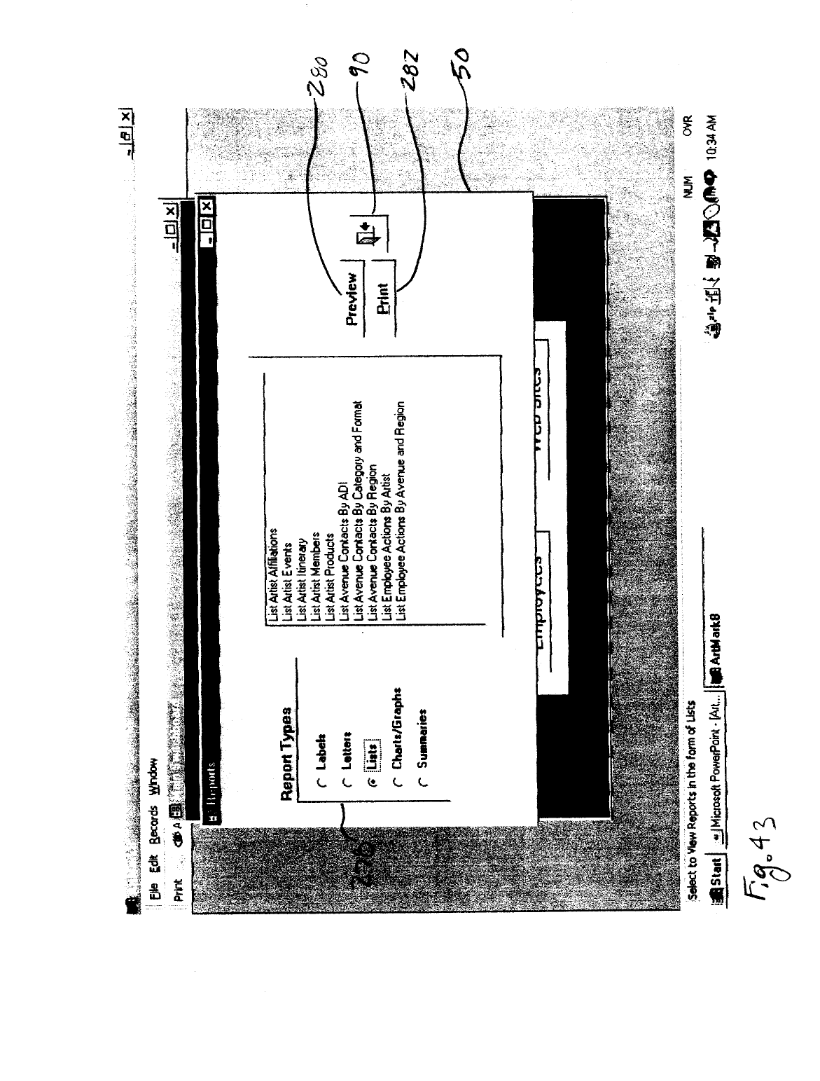

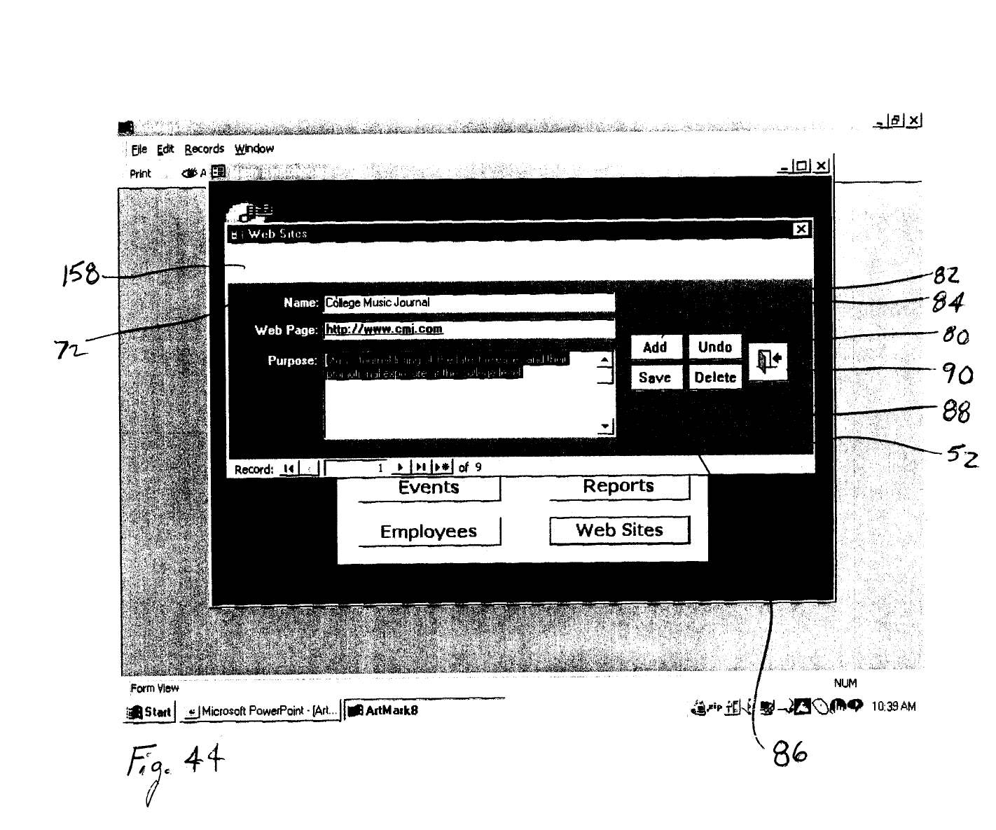

The illustrated main navigational window 12 includes a main portion having two columns of five buttons 14-32, each button is adapted for opening a desired window to perform a desired function. The buttons 14-22 in the first or left column, in descending order, include an “Artists” button 14 for opening an “Artist Organization” window 34 (FIG. 2) to utilize information relating to particular artists, an “Avenues” button 16 for opening and “Avenues” window 36 (FIG. 10) to utilize information relating to various avenues of marketing, a “Contacts” button 18 for opening a “Contacts” window 38 (FIG. 24) to utilize information relating to contact persons at various companies and organizations, an “Events” button 20 for opening an “Events” window 40 (FIG. 27) to utilize information relating to promotional or marketing events, and an “Employees” button 22 for opening an “Employees” window 42 (FIG. 29) to utilize information relating to various employees of the company utilizing the database program 10. The buttons 24-32 in the second or right column, in descending order, include an “Calendar” button 24 for opening a “Calendar Choice” window 44 (FIG. 32) to utilize information relating to particular employees, artists and/or contacts, a “Search” button 26 for opening a “Search And Apply” window 46 (FIG. 37) to search for and/or update information, an “Archives” 28 button for opening an “Archives” window 48 (FIG. 41) to store information in an archive and/or retrieve information from the archive, a “Reports” button 30 for opening a “Reports” window 50 (FIG. 43) to display and/or print reports of information in various formats, and a “Web Sites” button 32 for opening a “Web Sites” window 52 (FIG. 44) to display web site information stored in the database program 10. The main navigational window 12 also includes an “Exit” button 54 for closing the main navigational window 12 and exiting the database program 10. The “Exit” button 54 is preferably located to the right of the main portion near the right edge of the main navigational window 12 and vertically near the middle of the main navigational window 12. It is noted that the main navigation window 12 can alternatively have a fewer or greater number of buttons 14-32, 54 and can alternatively have different buttons 14-32, 54 within the scope of the present invention. It is also noted that the buttons 14-32, 54 can alternatively be arranged in other orders or other configurations within the scope of the present invention. The term “button” as used in this specification and the claims means a point or area on the screen in which a mouse is clicked, a menu, tabs, or any other suitable means for opening or moving to a different active window or screen or layer of a window or screen.

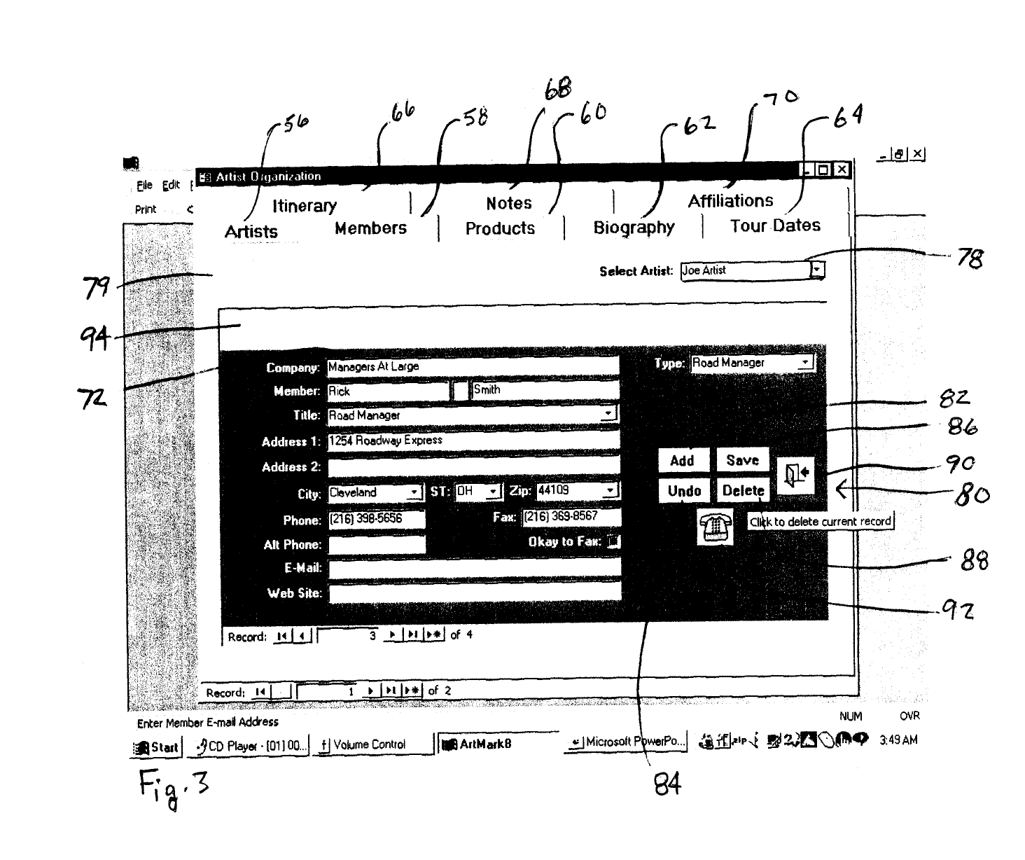

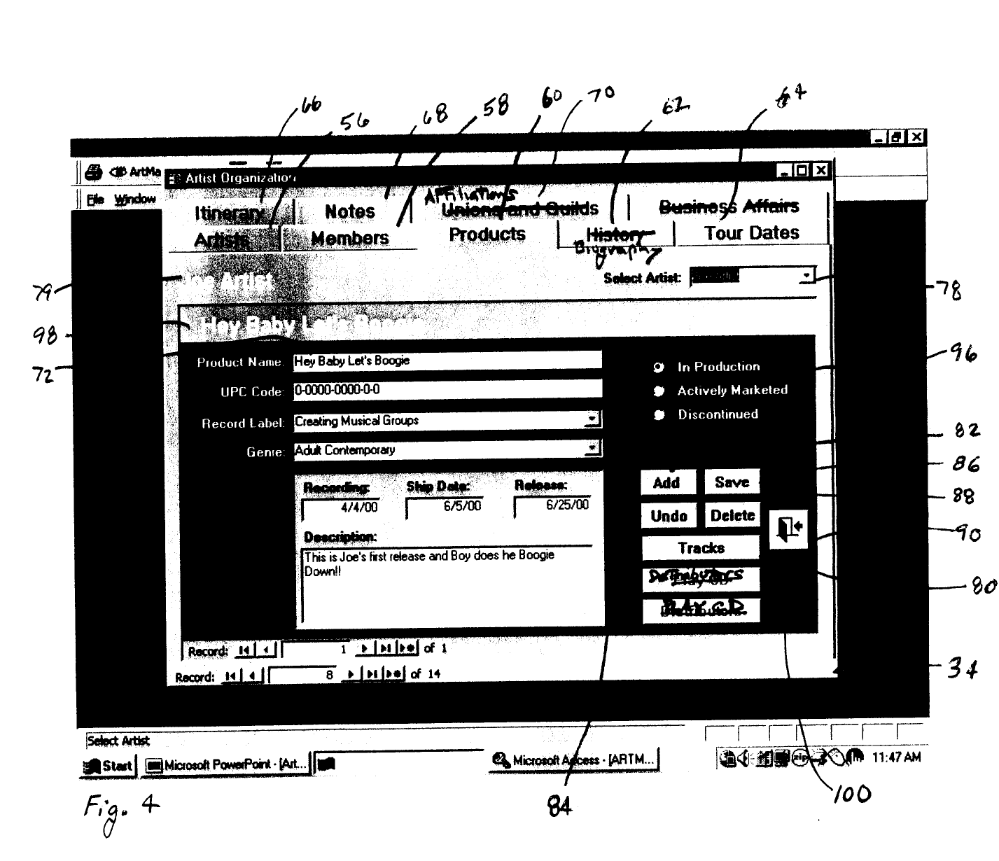

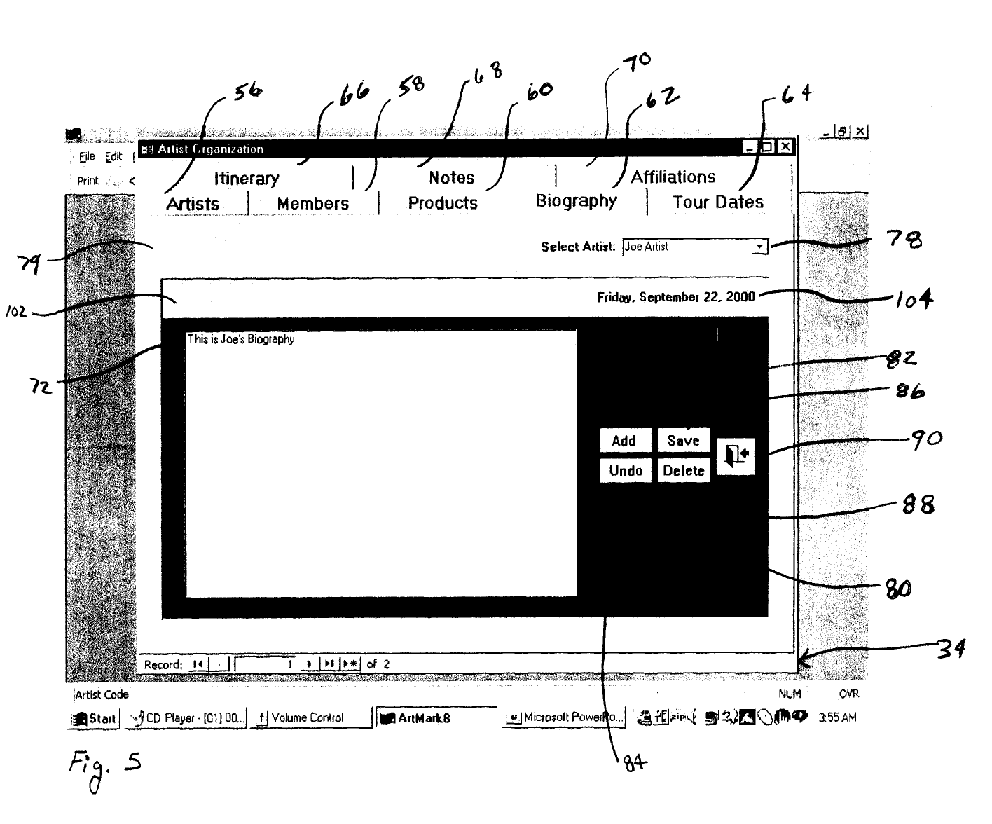

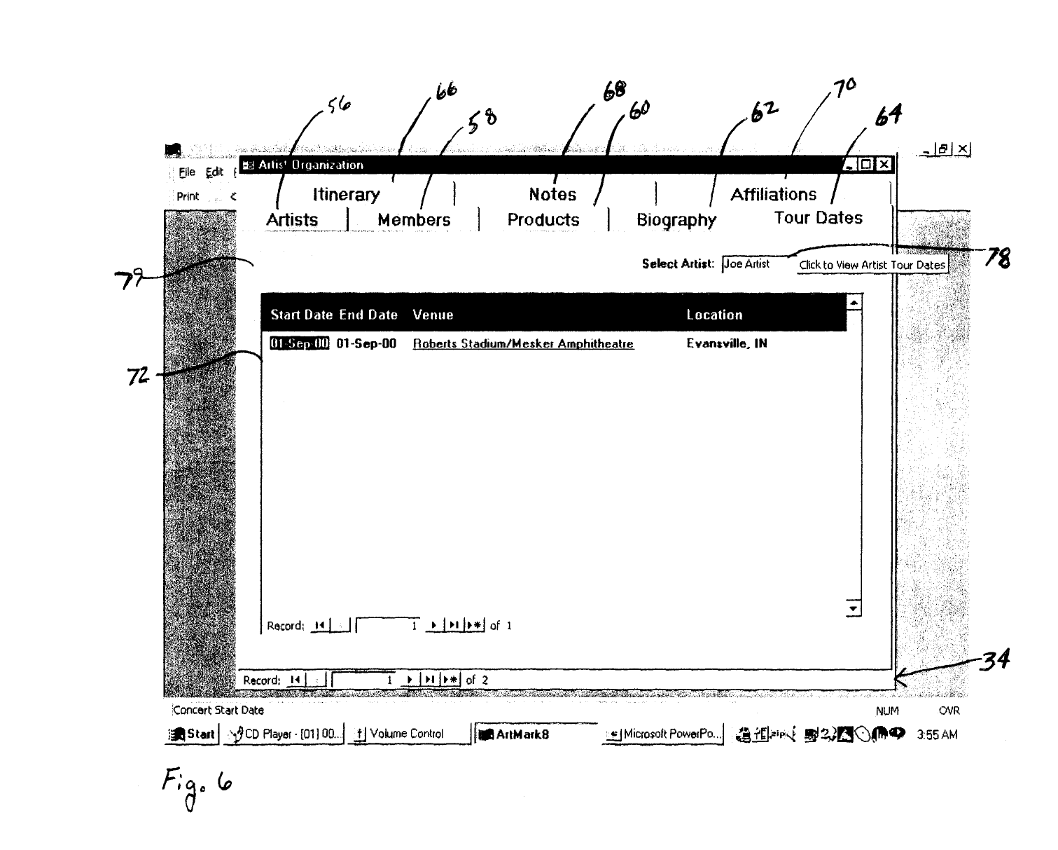

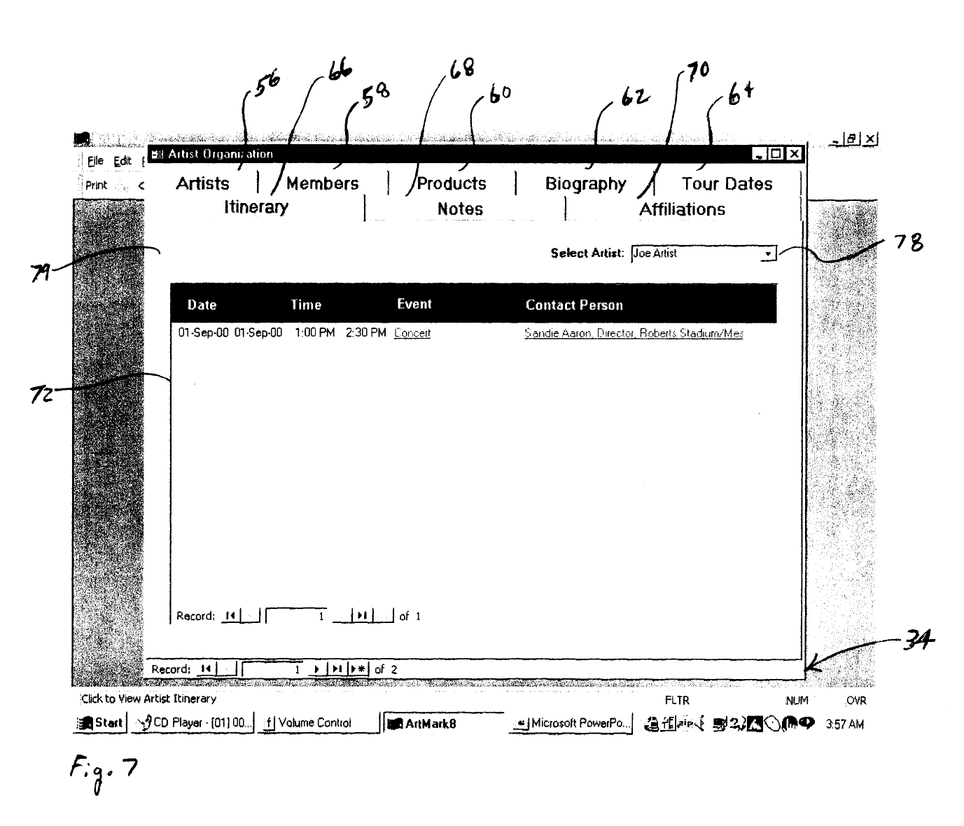

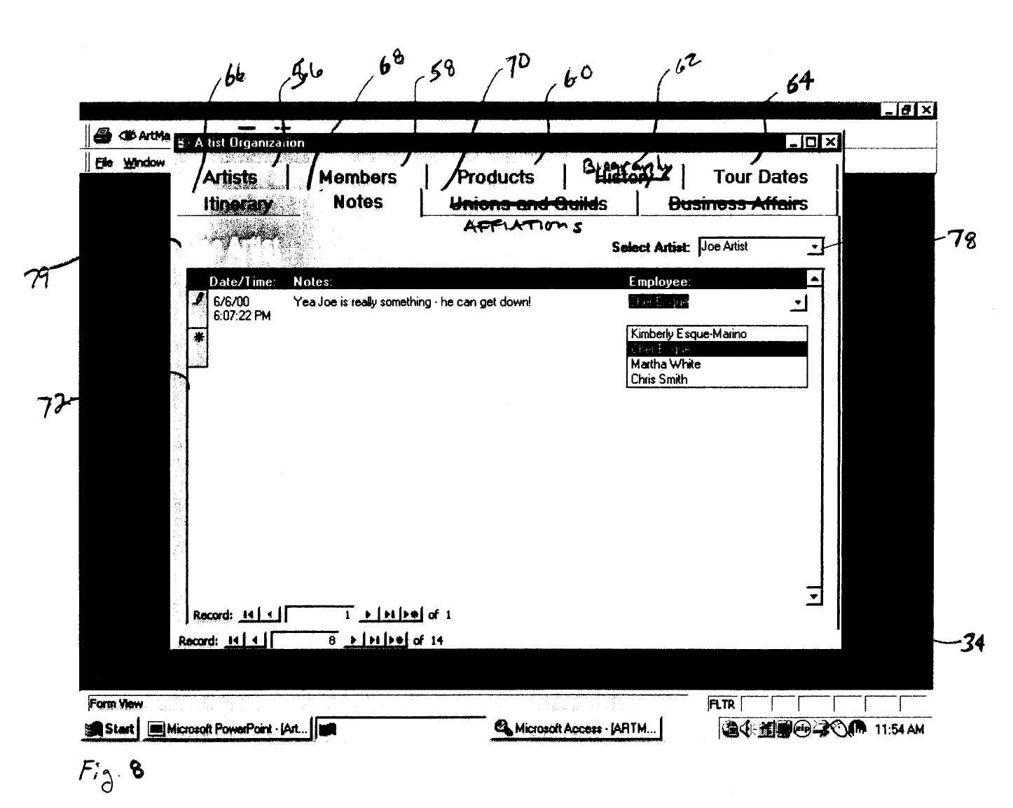

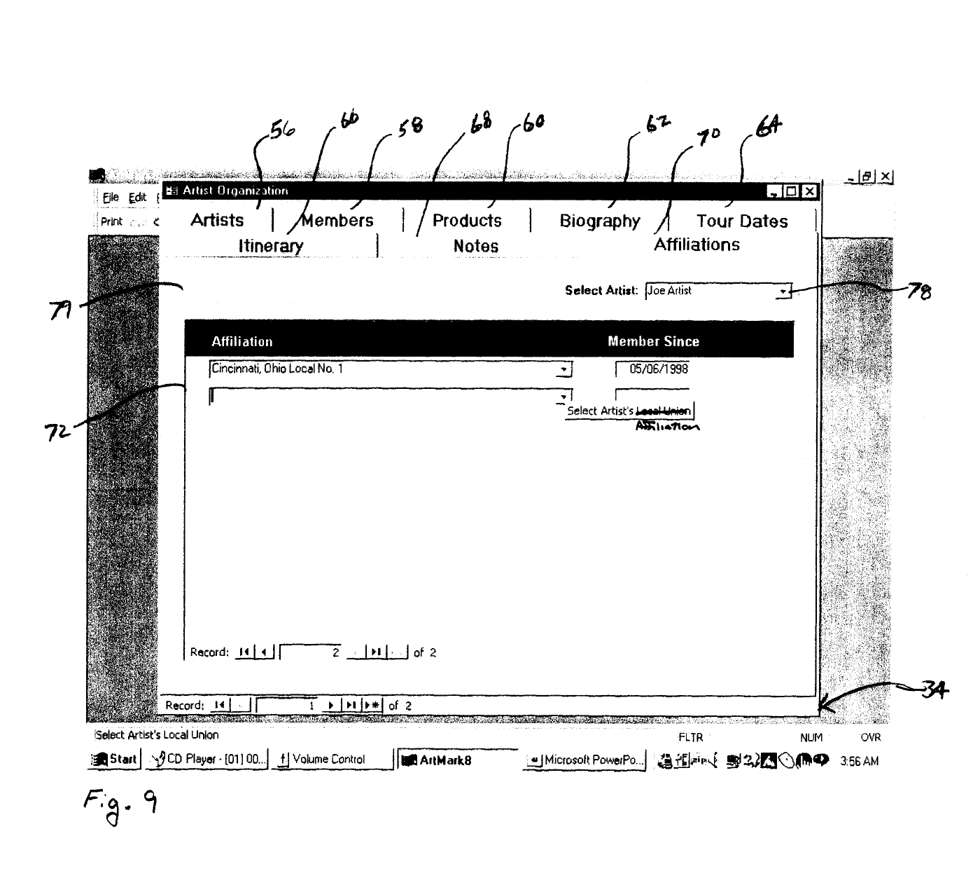

As best shown in FIG. 2, the “Artist Organization” window 34 includes eight tabs 56-70 including an “Artists” tab 56 for displaying a layer of the window 34 (FIG. 2) to utilize information relating to a particular artist, a “Members” tab 58 for displaying a layer of the window 34 (FIG. 3) to utilize information relating to persons associated with a particular artist, a “Products” tab 60 for displaying a layer of the window 34 (FIG. 4) to utilize information relating to products of a particular artist, a “Biography” tab 62 for displaying a layer of the window 34 (FIG. 5) to utilize a biography of a particular artist, a “Tour Dates” tab 64 for displaying a layer of the window 34 (FIG. 6) to utilize information related tours of a particular artist, an “Itinerary tab” 66 for displaying a layer of the window 34 (FIG. 7) to utilize information relating to an itinerary of a particular artist, a “Notes” tab 68 for displaying a layer of the window 34 (FIG. 8) to utilize information relating to notes of a particular artist, and an “Affiliations” tab 70 for displaying a layer of the window 34 (FIG. 9) to utilize information relating to affiliations of a particular artist. It is noted that the “Artist Organization” window 34 can alternatively have a fewer or greater number of tabs 56-70 and/or can alternatively have different tabs 56-70 within the scope of the present invention. It is also noted that the tabs 56-70 can alternatively be arranged in other orders or other configurations within the scope of the present invention and can alternatively be buttons, menus, or other suitable means for displaying the desired information.

As shown in FIG. 2, the “Artists” tab or layer 56 includes data fields or distinct data boxes 72 for entering and displaying specific contact and format information regarding a particular artist. Some data fields 72 such as “E-Mail” and “Web Site” data fields 72 preferably display hyperlinks adapted to cooperate with suitable intranet and/or internet software. The layer 56 also includes additional data fields 74 for entering and displaying whether the artist is in development or actually marketed. These additional data fields 74 preferably include pull down menus containing all possible choices. The illustrated layer 56 further includes a data field 76 for indicating whether the artist is deceased. Information or data can be input for entering a new artist into the data base program 10 or displayed for showing a stored artist. Information relating to a stored artist can be retrieved by indicated the stored artist in the “Select Artist” field 78 which preferably includes a pull down menu containing all stored artists. The name 79 of the currently displayed artist is preferably displayed in the upper left corner of the layer 56. The number of the record and the total number of records are indicated in the lower left corner of the window as well as buttons for navigating through the records.

The layer 56 also includes a button grouping 80 located near the edge of the window and vertically near the middle of the window so that it is to the right and/or below the data fields. The illustrated grouping generally includes three columns of buttons. The first or left column includes an “Add” button 82 located above an “Undo” button 84. The “Add” button 82 is utilized to provide a new record with clear data fields 72, 74, 76, 78 so that new information can be input. The “Undo” button 84 is utilized to undo the last action taken as is common in the art. The second or center column includes a “Save” button 86 located above a “Delete” button 88. The “Save” button 86 is utilized to save any data entered into the data fields 72, 74, 76, 78 as is common in the art. The “Delete” button 88 is utilized to delete the information in the data fields 72, 74, 76, 78 as is common in the art. The third or right column includes a close button 90 which is identified by the illustration of a door closing. The close button 90 is utilized to close the “Artist Organization” window 34 as is common in the art. The illustrated button grouping 80 also includes a call or phone button 92 which is identified by an illustrated telephone and is centrally located between and below the first and second columns. The call button 92 is utilized to automatically attempt to connect a communication line with the displayed artist. It is noted that this illustrated group is the subject of U.S. Design Pat. No. D512,071 which is owned by the present applicant.

As shown in FIG. 3, the “Members” tab or layer 58 includes data fields or distinct data boxes 72 for entering and displaying specific contact information regarding persons associated with a particular artist such as, for example, managers, road managers, personal assistants, publicists, accountants, lawyers, and the like. Some data fields 72 such as “E-Mail” and “Web Site” data fields preferably display hyperlinks adapted to cooperate with suitable intranet and/or internet software. The illustrated layer 58 further includes a data field 76 for indicating whether the artist is deceased. Information or data can be input for entering a new member into the data base program or displayed for showing a stored member. Information relating to a stored artist can be retrieved by indicated the stored artist in the “Select Artist” field 78 which preferably includes a pull down menu containing all stored artists. The name 79 of the artist associated with the currently displayed member or person is preferably displayed in the upper left corner of the layer 58. Additionally, the title 94 of the currently displayed member or person is displayed below the name of the artist. The number of the record and the total number of records are indicated in the lower left corner of the layer as well as buttons for navigating through the records. A button grouping 80 as described hereinabove with regard to the “Artists” layer 56 of FIG. 2 is also provided.

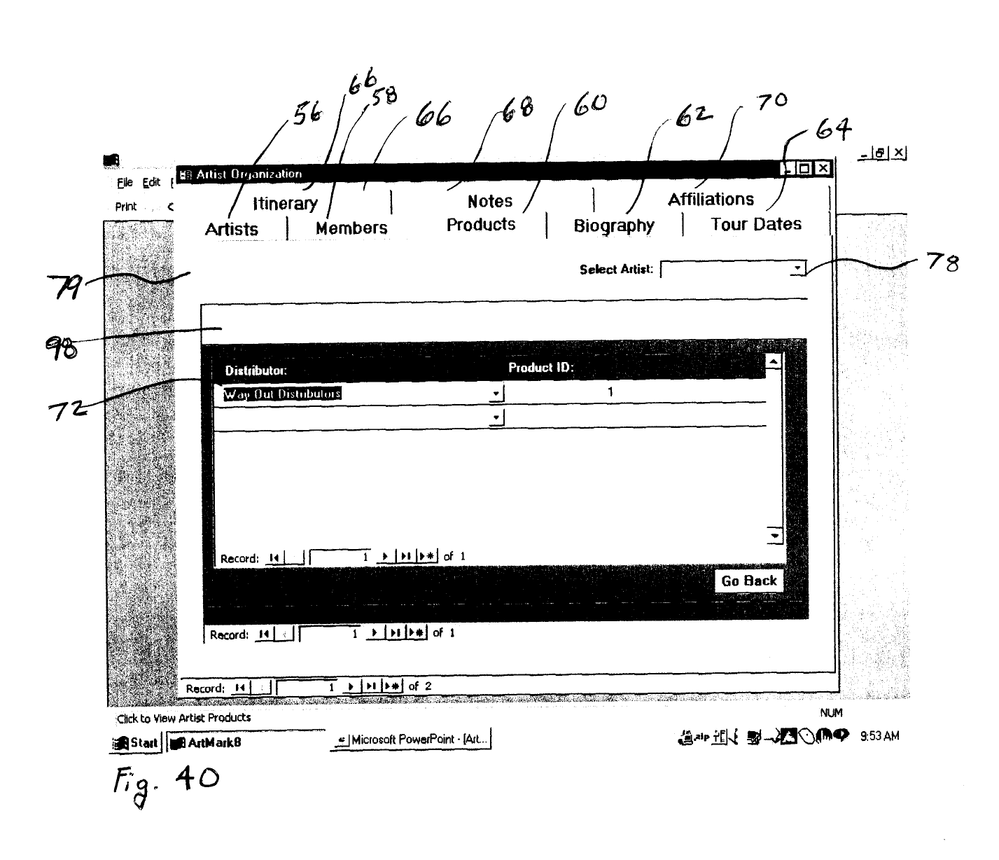

As shown in FIG. 4, the “Products” tab or layer 60 includes data fields or distinct data boxes 72 for entering and displaying specific information regarding products associated with a particular artist such as, for example, compact discs, cassette tapes, digital versatile discs and the like. The data fields 72 preferably include fields for recording, ship and release dates for the product. The illustrated layer further includes a data field 96 for indicating whether the product is in production, actively marketed, and/or discontinued. Information or data can be input for entering a new product into the data base program or displayed for showing a stored product. Information relating to a stored artist can be retrieved by indicated the stored artist in the “Select Artist” field 78 which preferably includes a pull down menu containing all stored artists. The name 79 of the artist associated with the currently displayed product is preferably displayed in the upper left corner of the layer. Additionally, the name 98 of the currently displayed product is displayed below the name 79 of the artist. The number of the record and the total number of records are indicated in the lower left corner of the layer as well as buttons for navigating through the records. A button grouping 80 as described hereinabove with regard to the “Artists” layer 56 of FIG. 2 is also provided. However, in place of the call button 90 is a “Track” button 100 which opens a window (not specifically shown) containing a listing of each of the tracks of the product along with information about each track such as, for example, title and running time. A “Distributors” button located below the “Track” button and opens a “Distributors” window (FIG. 40) which lists the distributors for the product.

As shown in FIG. 5, the “Biography” tab or layer 62 includes a data field or distinct data box 72 for entering and displaying specific information regarding a biography associated with a particular artist. The information can be input for entering a new biography into the data base program 10 or displayed for showing a stored biography. Information relating to a stored artist can be retrieved by indicated the stored artist in the “Select Artist” field 78 which preferably includes a pull down menu containing all stored artists. The name 79 of the artist associated with the currently displayed biography is preferably displayed in the upper left corner of the layer. Additionally, the title “biography” 102 is displayed below the name 79 of the artist. Furthermore, the current date 104 is preferably displayed near the upper right corner of the layer 62. The number of the record and the total number of records are indicated in the lower left corner of the layer as well as buttons for navigating through the records. A button grouping 80 as described hereinabove with regard to the “Artists” layer 56 of FIG. 2 is also provided. However, the call button 92 is eliminated.

As shown in FIG. 6, the “Tour Dates” tab or layer 64 includes a data field or distinct data box 72 for displaying specific information regarding tours for the particular artist. The information preferably includes a start date for each tour stop, an end date for each tour stop, a venue for each tour stop, and the location of each venue. The venue information preferably includes hyperlinks adapted to cooperate with suitable intranet and/or internet software. Information or data can be displayed for showing stored tour dates. Information relating to a stored artist can be retrieved by indicated the stored artist in the “Select Artist” field 78 which preferably includes a pull down menu containing all stored artists. The name 79 of the artist associated with the currently displayed tour dates is preferably displayed in the upper left corner of the layer. The number of the record and the total number of records are indicated in the lower left corner of the layer as well as buttons for navigating through the records.

As shown in FIG. 7, the “Itinerary” tab or layer 66 includes a data field or distinct data box 72 for entering and displaying specific information regarding an itinerary for a particular artist. The information preferably includes a date for each event, a time for each event, the type of event such as, for example, concert, radio appearance, television appearance, or a retail store signing appearance, and the name, title and company for a contact person for the event. The contact person information preferably includes a hyperlink to a contact window for the person as described in more detail hereinafter. Information or data can be displayed for showing stored itineraries. Information relating to a stored artist can be retrieved by indicated the stored artist in the “Select Artist” field 78 which preferably includes a pull down menu containing all stored artists. The name 79 of the artist associated with the currently displayed itinerary is preferably displayed in the upper left corner of the layer. The number of the record and the total number of records are indicated in the lower left corner of the layer as well as buttons for navigating through the records.

As shown in FIG. 8, the “Notes” tab or layer 68 includes a data field or distinct data box 72 for entering and displaying specific information regarding notes for a particular artist. The information preferably includes a date and time the note is entered, a note, and the name of the employee which entered the note. The data field 72 for the name of the employee preferably includes a pull down menu of all stored employees. Information or data can be displayed for showing stored notes. Information relating to a stored artist can be retrieved by indicated the stored artist in the “Select Artist” field 78 which preferably includes a pull down menu containing all stored artists. The name 79 of the artist associated with the currently displayed notes is preferably displayed in the upper left corner of the layer. The number of the record and the total number of records are indicated in the lower left corner of the layer as well as buttons for navigating through the records.

As shown in FIG. 9, the “Affiliations” tab or layer 70 includes a data field or distinct data box 78 for entering and displaying specific information regarding affiliations for a particular artist such as, for example, labor unions, guilds, associations, and the like. The information preferably includes the name of the affiliated organization and the beginning membership date for the artist. The data field for the name of the affiliated organization preferably includes a pull down menu of all stored organizations. Information can be displayed for showing stored affiliations. Information relating to a stored artist can be retrieved by indicated the stored artist in the “Select Artist” field 78 which preferably includes a pull down menu containing all stored artists. The name 79 of the artist associated with the currently displayed affiliations is preferably displayed in the upper left corner of the layer. The number of the record and the total number of records are indicated in the lower left corner of the layer as well as buttons for navigating through the records.

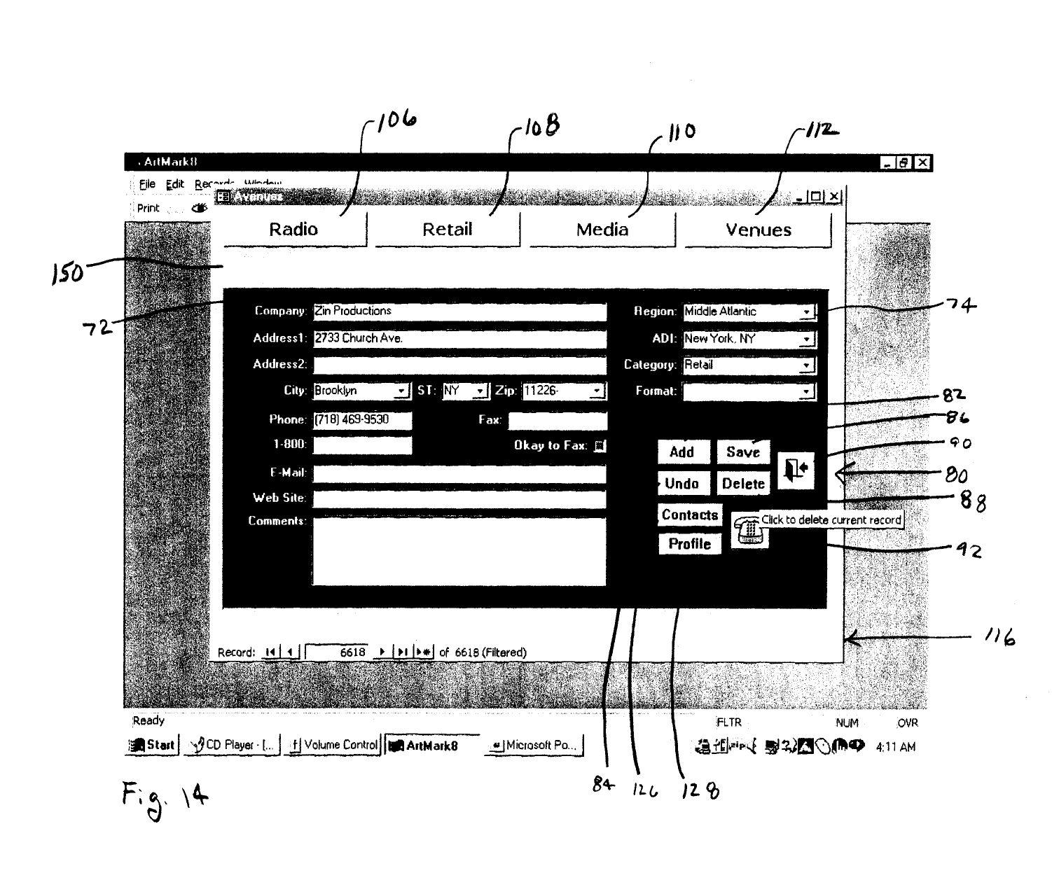

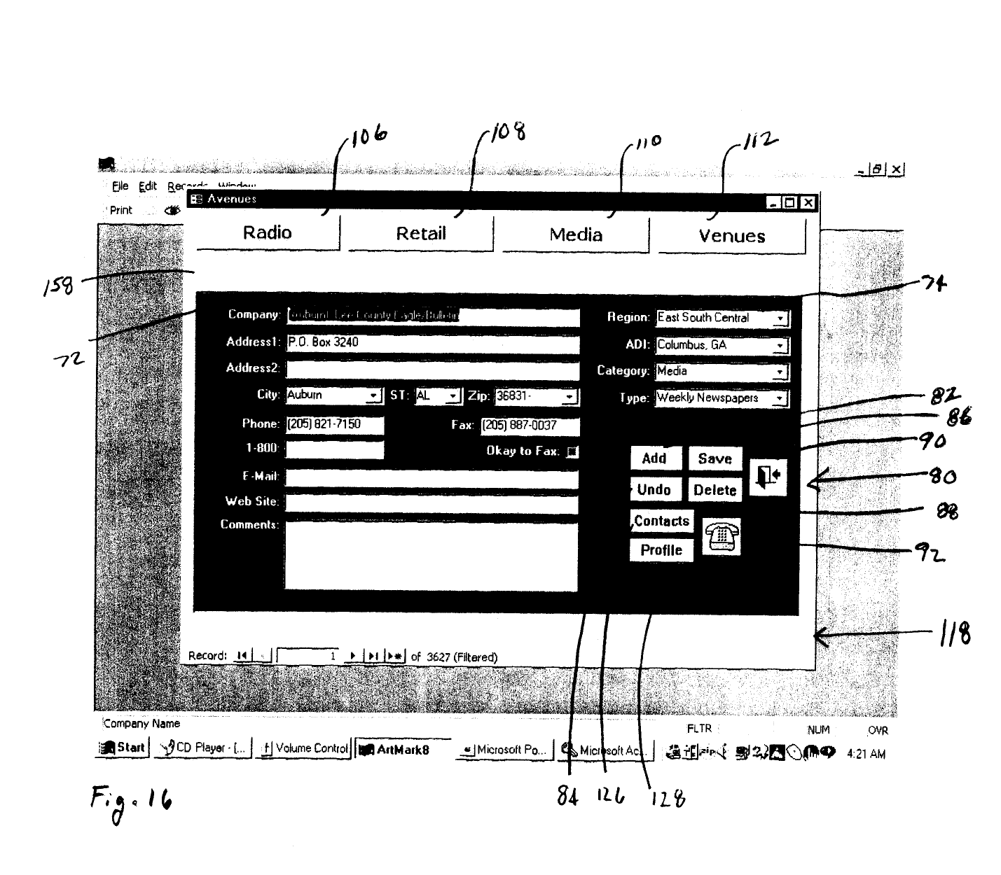

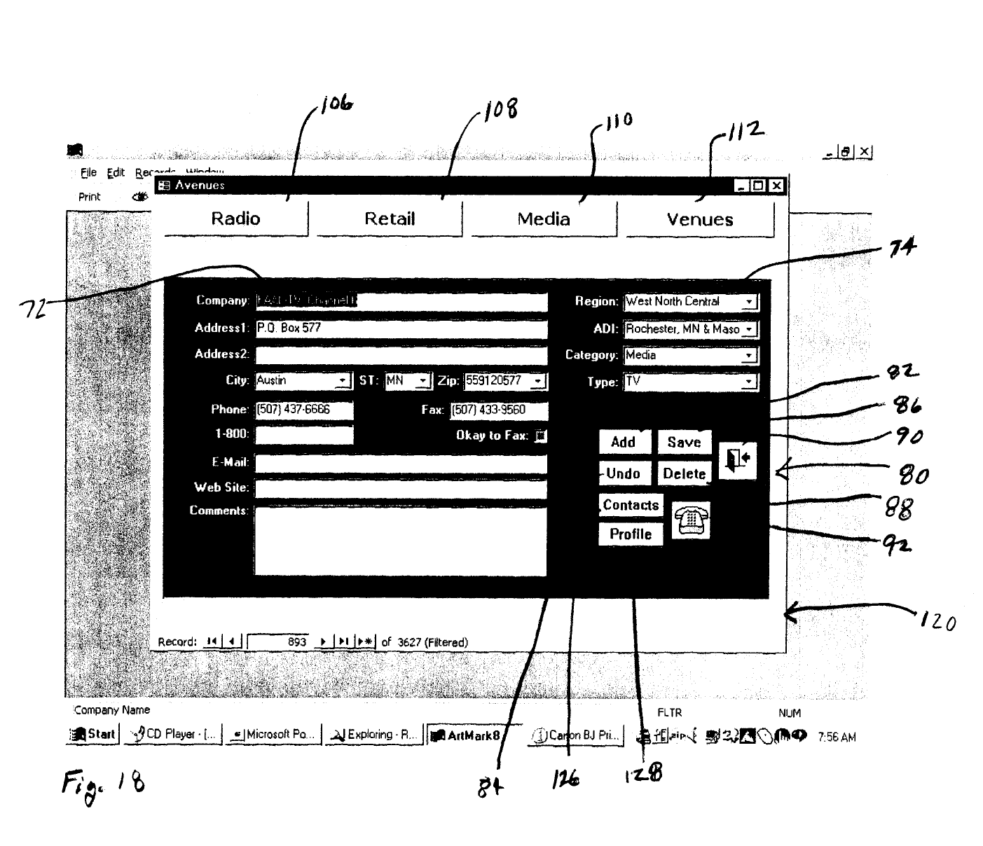

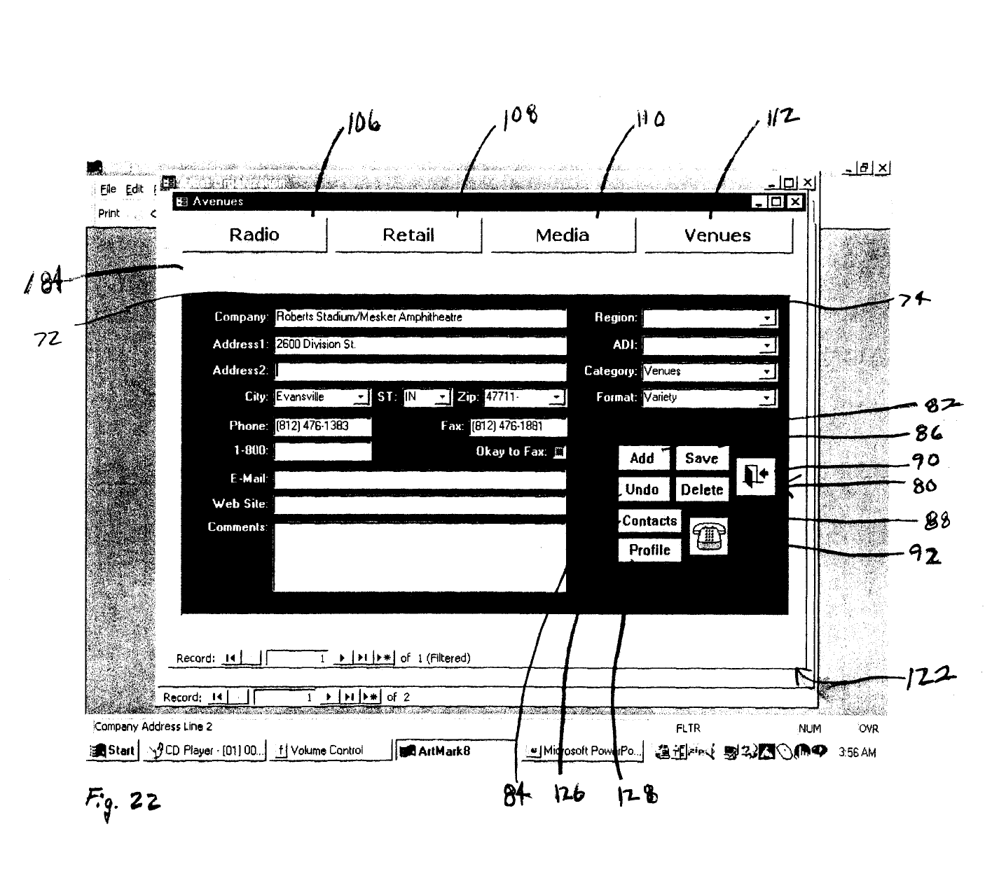

As best shown in FIG. 10, the “Avenues” window 36 includes four buttons 106-112 including an “Radio” button 106 for opening a radio window 114 (FIG. 10) to utilize information relating to a particular radio station, a “Retail” button 108 for opening a retail window 116 (FIG. 14) to utilize information relating a particular retailer, a “Media” button 110 for opening media windows 118, 120 (FIGS. 16 and 18) to utilize information relating to a particular media such as, for example a newspaper, magazine, and/or a television station, and a “Venue” button 112 for opening a venue window 122 (FIG. 22) to utilize information relating to a particular venue. The illustrated buttons 106-112 are horizontally spaced apart across the top of the window. It is noted that the “Avenues” window 36 can alternatively have a fewer or greater number of such buttons 106-112 and/or can alternatively have different buttons 106-112 within the scope of the present invention. It is also noted that the buttons 106-112 can alternatively be arranged in other orders or other configurations within the scope of the present invention and can alternatively be menus, tabs, or other suitable means for displaying the desired information.

As shown in FIG. 10, the radio window 114 includes data fields or distinct data boxes 72 for entering and displaying specific information regarding a particular radio station. Some data fields such as “E-Mail” and “Web Site” data fields preferably display hyperlinks adapted to cooperate with suitable intranet and/or internet software. The window also includes additional data fields 76 for entering and displaying the region (preferably, one of about nine geographic regions of the United States), the area of dominant influence (ADI) (preferably, one of about 210 major cities in the United States), category (in this case radio), and the format of the radio station (preferably, one of about twelve types of music). These additional data fields 76 preferably include pull down menus containing all possible choices. Information or data can be input for entering a new radio station into the data base program 10 or displayed for showing a stored radio station. The name or company 124 of the currently displayed radio station is preferably displayed in the upper left corner of the window 114. The number of the record and the total number of records are indicated in the lower left corner of the window as well as buttons for navigating through the records.

The window 114 also includes the button grouping 80 such as that described hereinabove with regard to the “Artists Organization” 34 window of FIG. 2. Also included, however are a “Contacts” button 126 and a “Profile button” 128 located below the first column of buttons and to the left of the call button 92. The “Contacts” button 126 is utilized to open the “contacts” window 38 to display information for contact persons for the radio station as described in more detail hereinbelow. The “Profile” button 128 is utilized to open a “Radio Profile” window 130.

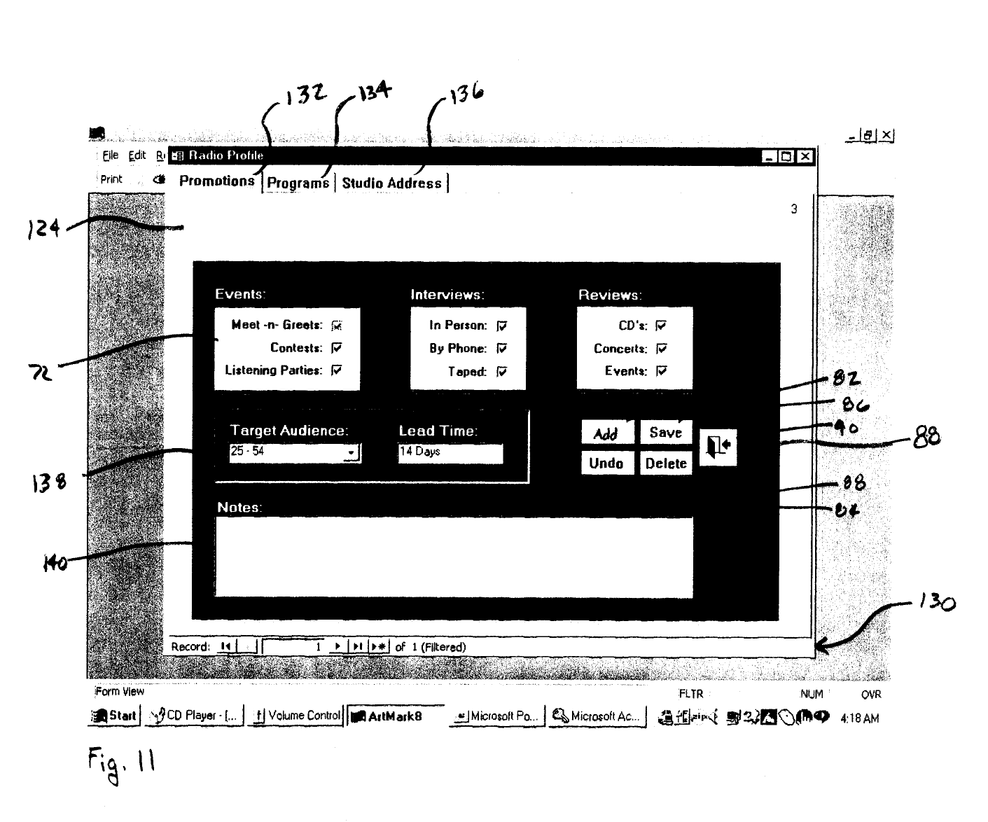

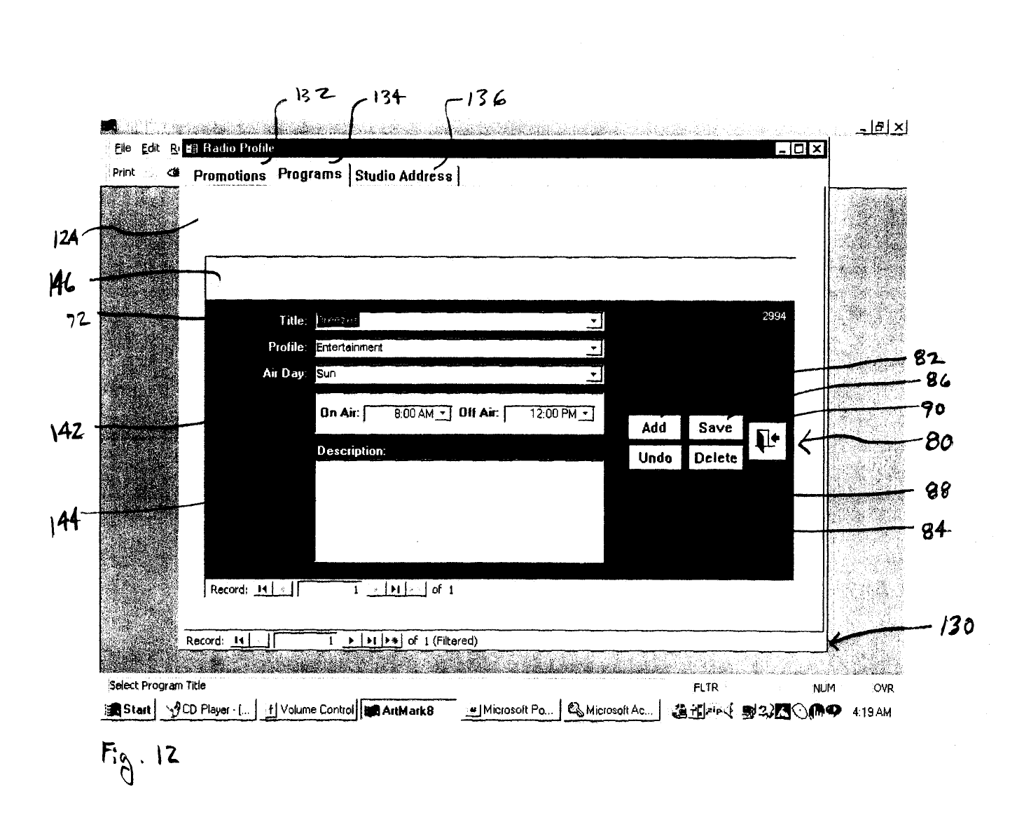

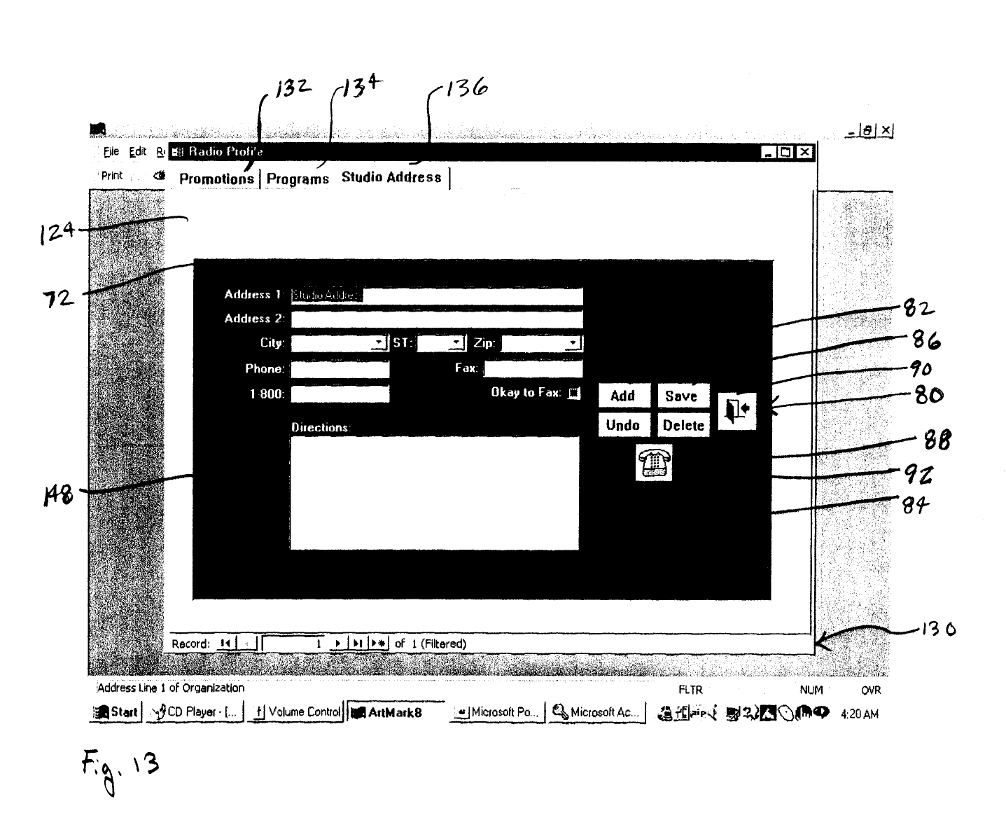

As best shown in FIG. 11, the “Radio Profiles” window 130 includes three tabs 132, 134, 136 including a “Promotions” tab 132 for displaying a layer of the window 130 (FIG. 11) to utilize information relating to promotions of a particular radio station, a “Programs” tab 134 for displaying a layer of the window 130 (FIG. 12) to utilize information relating to programs associated with a particular radio station, and a “Studio Address” tab 136 for displaying a layer of the window 130 (FIG. 13) to utilize information relating to a studio address of a particular radio station. It is noted that the “Radio Profile” window 130 can alternatively have a fewer or greater number of tabs 132, 134, 136 and/or can alternatively have different tabs 132, 134, 136 within the scope of the present invention. It is also noted that the tabs 132, 134, 136 can alternatively be arranged in other orders or other configurations within the scope of the present invention and can alternatively be buttons, menus or other suitable means for displaying the desired information. The number of the record and the total number of records are indicated in the lower left corner of the layer as well as buttons for navigating through the records.

As shown in FIG. 11, the “Promotions” tab or layer 130 includes data fields or distinct data boxes 72 for entering and displaying specific information regarding promotions associated with a particular radio station such as, for example, types of events, types of interviews, and types of products reviewed. The layer 130 also includes additional data fields 138 for entering and displaying the target audience of the radio station and the lead time required for arranging a promotion. The target audience data field preferably includes a pull down menu containing possible choices. The illustrated layer 130 further includes a data field 140 for miscellaneous notes regarding promotions at the particular radio station. The name or company 124 of the radio station associated with the currently displayed promotion information is preferably displayed in the upper left corner of the layer 132. The button groping 80 as described hereinabove with regard to the “Artists” layer 56 of FIG. 2 is also provided. However, the call button 92 is eliminated.

As shown in FIG. 12, the “Programs” tab or layer 134 includes data fields or distinct data boxes 72 for entering and displaying specific information regarding programs associated with a particular radio station such as, for example, the title of the program, the profile of the program, and the air day of the program. These data fields preferably include pull down menus containing possible choices. The layer 134 also includes additional data fields for entering and displaying the on air and off air times for the program. The illustrated layer 134 further includes a data field 144 for miscellaneous notes regarding the program. The name or company 124 of the radio station associated with the currently displayed promotion information is preferably displayed in the upper left corner of the layer 134. Additionally, the name or title 146 of the program is preferably displayed below the name 124 of the radio station. The number of the record and the total number of records are indicated in the lower left corner of the layer as well as buttons for navigating through the records. The button grouping 80 as described hereinabove with regard to the “Artists” layer 34 of FIG. 2 is also provided. However, the call button 92 is eliminated.

As shown in FIG. 13, the “Studio Address” tab or layer 136 includes data fields or distinct data boxes 72 for entering and displaying specific information regarding the radio studio where programs take place. Some of these data fields 72 can include pull down menus containing possible choices. The illustrated layer 136 also includes a data field 148 for driving directions to the radio studio. The name or company 124 of the radio station associated with the currently displayed studio address information is preferably displayed in the upper left corner of the layer 136. The button grouping 80 as described hereinabove with regard to the “Artists” layer 34 of FIG. 2 is also provided.

As shown in FIG. 14, the retail window 116 includes data fields or distinct data boxes 72 for entering and displaying specific information regarding a particular retail outlet. Some data fields such as “E-Mail” and “Web Site” data fields preferably display hyperlinks adapted to cooperate with suitable intranet and/or internet software. The window 116 also includes additional data fields 74 for entering and displaying the region (preferably, one of about nine geographic regions of the United States), the area of dominant influence (ADI) (preferably, one of about 210 major cities in the United States), category (in this case retail), and the format of the retail outlet (preferably, one of about twelve types of music but is typically left blank for retail outlets). These additional data fields 74 preferably include pull down menus containing all possible choices. Information or data an be input for entering a new retail outlet into the data base program 10 or displayed for showing a stored retail outlet. The name or company 150 of the currently displayed retail outlet is preferably displayed in the upper left corner of the window 116. The number of the record and the total number of records are indicated in the lower left corner of the window as well as buttons for navigating through the records.

The window 116 also includes the button grouping 80 such as that described hereinabove with regard to the “Artists Organization” window 34 of FIG. 2. Also included, however are a “Contacts” button 126 and a “Profile button” 128 as discussed hereinabove and located below the first column of buttons and to the left of the call button 92. The “Contacts” button 126 is utilized to open the “contacts” window 38 to display information for contact persons for the radio station as described in more detail hereinbelow. The “Profile” button 128 is utilized to open a “Retail Profile” window 152.

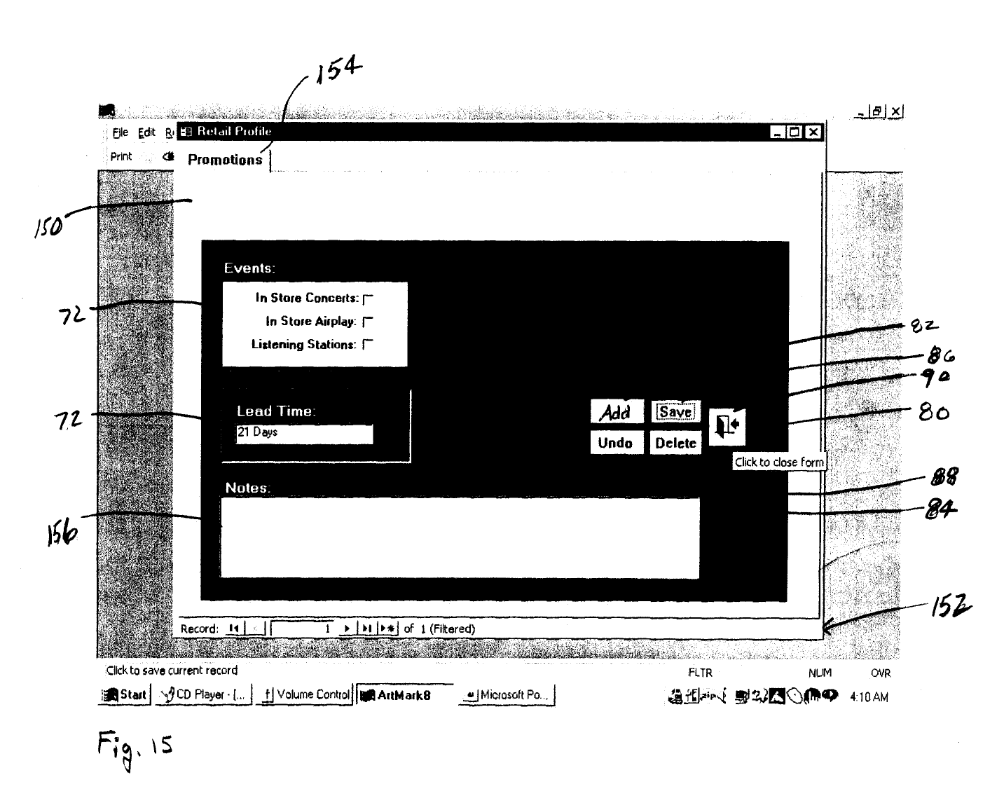

As best shown in FIG. 15, the “Retail Profiles” window 152 includes a single “Promotions” tab 154 for displaying a layer of the window 152 (FIG. 15) to utilize information relating to promotions of a particular retail outlet. It is noted that the “Retail Profile” window 152 can alternatively have a greater number of tabs 154 and/or can alternatively have a different tab 154 within the scope of the present invention. It is also noted that the tab 154 can alternatively be arranged in other configurations within the scope of the present invention and can alternatively be a button, menu, or other suitable means for displaying the desired information.

As shown in FIG. 15, the “Promotions” tab or layer 154 includes data fields or distinct data boxes 72 for entering and displaying specific information regarding promotions associated with a particular retail outlet such as, for example, types of events and the lead time required for arranging events. The illustrated layer 154 further includes a data field 156 for miscellaneous notes regarding promotions at the particular retail outlet. The name or company 150 of the retail outlet associated with the currently displayed promotion information is preferably displayed in the upper left corner of the layer. The button grouping 80 as described hereinabove with regard to the “Artists” layer 34 of FIG. 2 is also provided. However, the call button 92 is eliminated.

As shown in FIG. 16, the media/weekly newspaper window 118 includes data fields or distinct data boxes 72 for entering and displaying specific information regarding a particular weekly newspaper. Some data fields 72 such as “E-Mail” and “Web Site” data fields preferably display hyperlinks adapted to cooperate with suitable intranet and/or internet software. The window 118 also includes additional data fields 74 for entering and displaying the region (preferably, one of about nine geographic regions of the United States), the area of dominant influence (ADI) (preferably, one of about 210 major cities in the United States), category (in this case media), and the format of the media (in this case weekly newspapers). These additional data fields 74 preferably include pull down menus containing all possible choices. Information or data can be input for entering new weekly newspapers or other media into the database program 10 or displayed for showing a stored weekly newspaper or other media. The name or company 158 of the currently displayed weekly newspaper or other media is preferably displayed in the upper left corner of the window 118. The number of the record and the total number of records are indicated in the lower left corner of the window as well as buttons for navigating through the records.

The window 118 also includes the button grouping 80 such as that described hereinabove with regard to the “Artists Organization” 34 window of FIG. 2. Also included, however are a “Contacts” button 126 and a “Profile button” 128 as described hereinabove and located below the first column of buttons and to the left of the call button 90. The “Contacts” button 126 is utilized to open the “Contacts” window 38 to display information for contact persons for the weekly newspaper or other media as described in more detail hereinbelow. The “Profile” button 128 is utilized to open a “Newspaper and Magazines Profile” window 160.

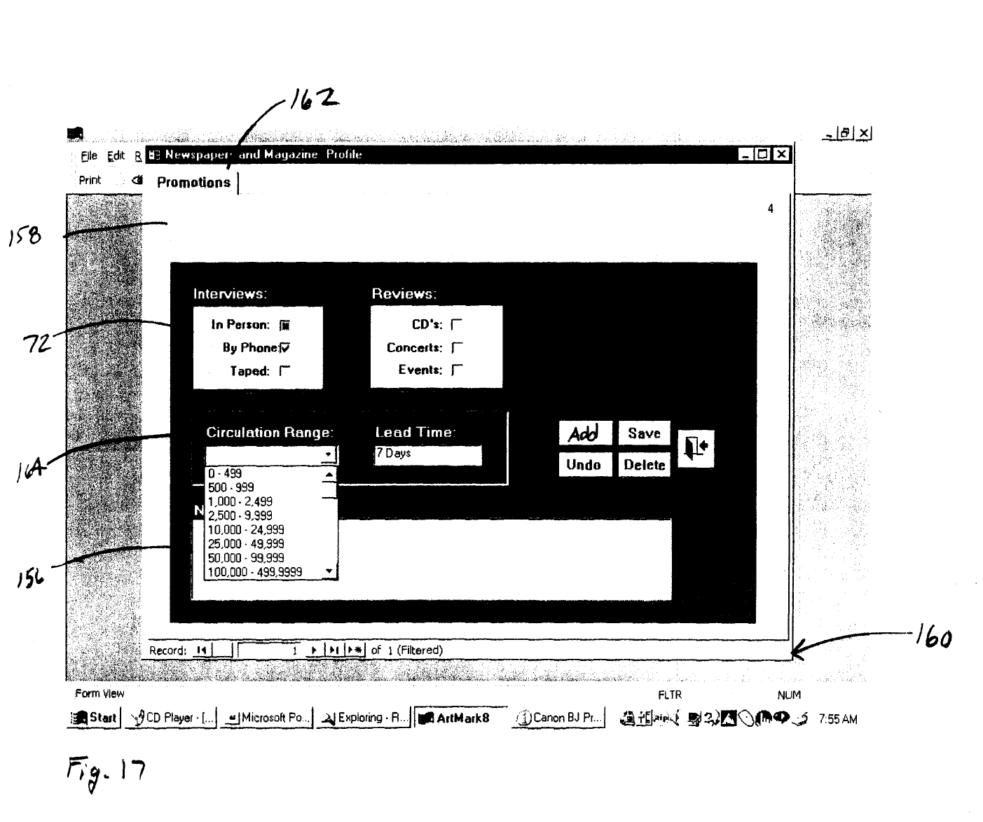

As best shown in FIG. 17, the “Newspapers and Magazines Profiles” window 160 includes a single “Promotions” tab 162 for displaying the single layer of the window 160 (FIG. 17) to utilize information relating to promotions of a particular newspaper or magazine. It is noted that the “Newspapers and Magazines Profile” window 160 can alternatively have a greater number of tabs 162 and/or can alternatively have a different tab 162 within the scope of the present invention. It is also noted that the tab 162 can alternatively be arranged in other configurations within the scope of the present invention and can alternatively be a button, menu, or other suitable means for displaying the desired information.

As shown in FIG. 17, the “Promotions” tab or layer 162 includes data fields or distinct data boxes 72 for entering and displaying specific information regarding promotions associated with a particular newspaper or magazine such as, for example, types of interviews and the types of reviews. The layer 162 also includes additional data fields 164 for entering and displaying the circulation range of the newspaper or magazine and the lead time required for arranging a promotion. The circulation range data field preferably includes a pull down menu containing possible choices. The illustrated layer 162 further includes a data field 156 for miscellaneous notes regarding promotions at the particular retail outlet. The name or company 158 of the newspaper or magazine associated with the currently displayed promotion information is preferably displayed in the upper left corner of the layer. The button grouping as described hereinabove with regard to the “Artists” layer 34 of FIG. 2 is also provided. However, the call button 92 is eliminated.

As shown in FIG. 18, the media/TV window 120 includes data fields or distinct data boxes 72 for entering and displaying specific information regarding a particular television station. Some data fields 72 such as “E-Mail” and “Web Site” data fields preferably display hyperlinks adapted to cooperate with suitable intranet and/or internet software. The window 120 also includes additional data fields 74 for entering and displaying the region (preferably, one of about nine geographic regions of the United States), the area of dominant influence (ADI) (preferably, one of about 210 major cities in the United States), category (in this case media), and the format of the media (in this case TV). These additional data fields 74 preferably include pull down menus containing all possible choices. Information or data can be input for entering new television stations or other media into the data base program 10 or displayed for showing stored television station or other media. The name or company 166 of the currently displayed television station or other media is preferably displayed in the upper left corner of the window 120. The number of the record and the total number of records are indicated in the lower left corner of the window as well as buttons for navigating through the records.

The window 120 also includes the button grouping 80 such as that described hereinabove with regard to the “Artists Organization” window 34 of FIG. 2. Also included, however, are a “Contacts” button 126 and a “Profile button” as discussed hereinabove and located below the first column of buttons and to the left of the call button 92. The “Contacts” button 126 is utilized to open the “Contacts” window 38 to display information for contact persons for the television station or other media as described in more detail hereinbelow. The “Profile” button 128 is utilized to open a “TV Profile” window 168.

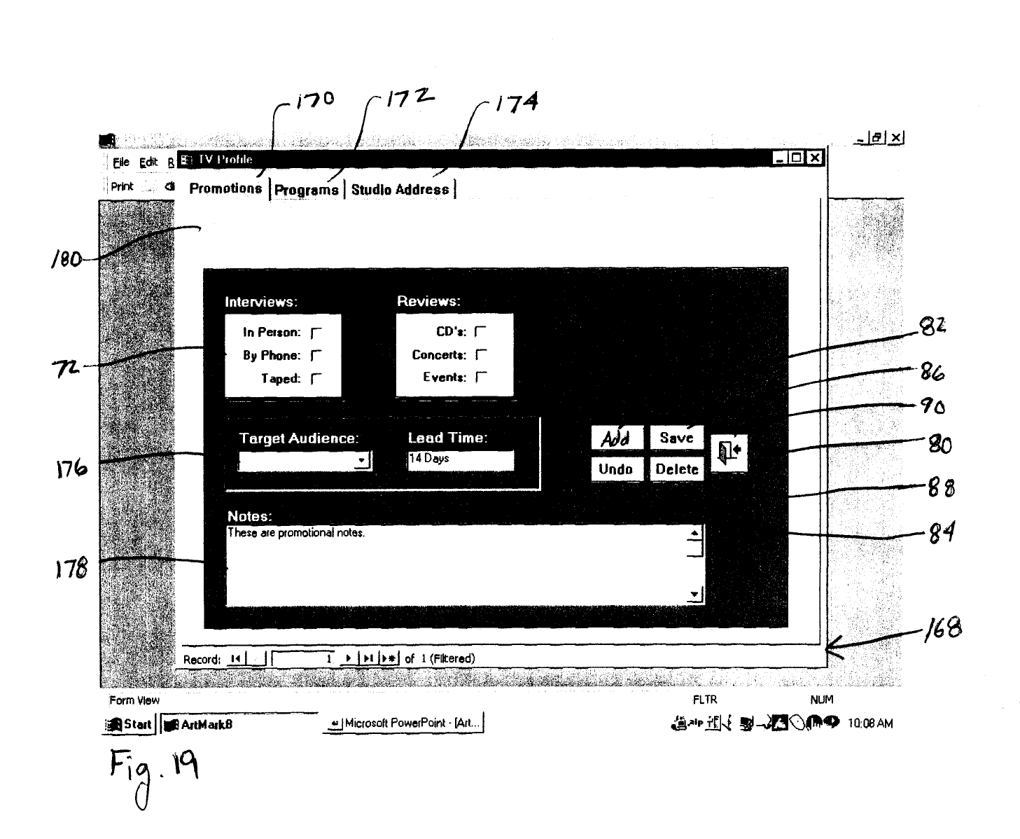

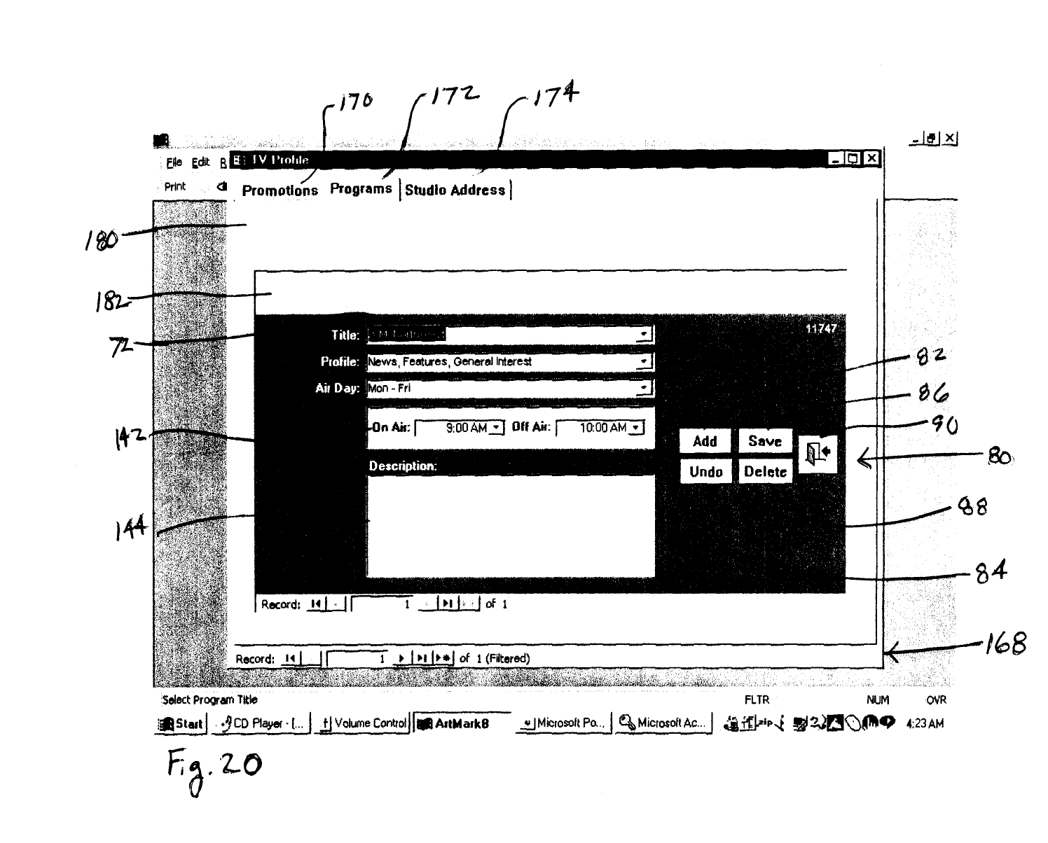

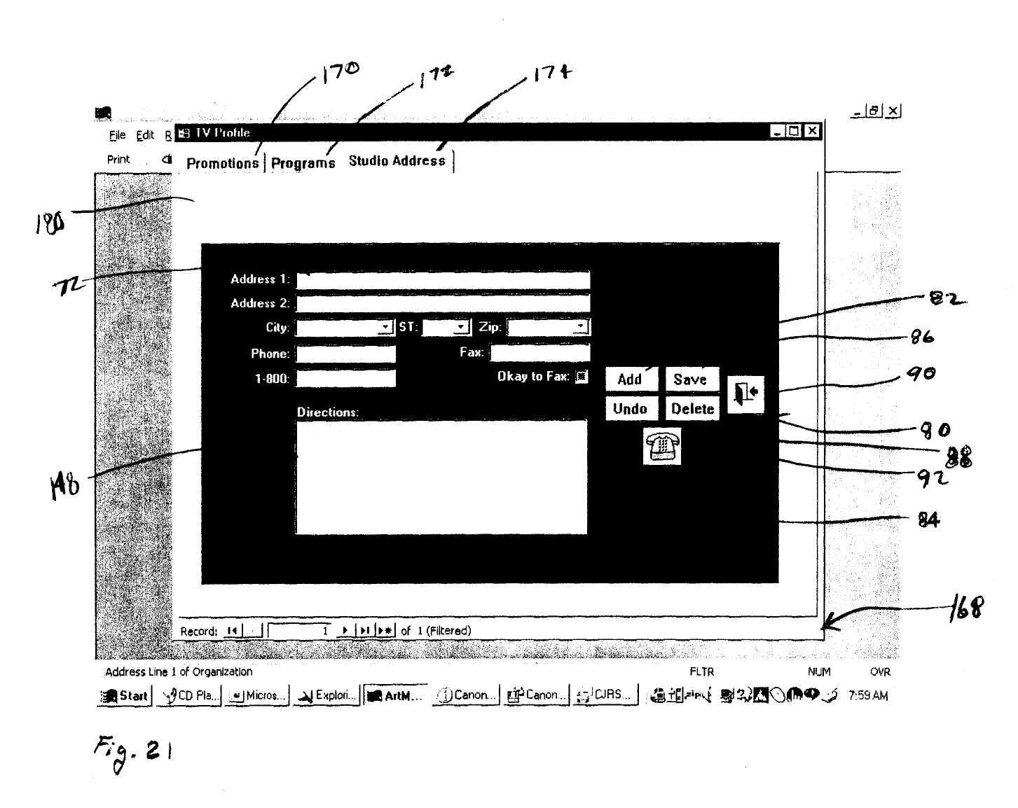

As best shown in FIG. 19, the “TV Profiles” window 168 includes three tabs 170, 172, 174 including a “Promotions” tab 170 for displaying a layer of the window 168 (FIG. 19) to utilize information relating to promotions of a particular television station, a “Programs” tab 172 for displaying a layer of the window 168 (FIG. 20) to utilize information relating to programs associated with a particular television station, and a “Studio Address” tab 174 for displaying a layer of the window 168 (FIG. 21) to utilize information relating to a studio address of a particular television station. It is noted that the “TV Profile” window 168 can alternatively have a fewer or greater number of tabs 170, 172, 174 and/or can alternatively have different tabs 170, 172, 174 within the scope of the present invention. It is also noted that the tabs 170, 172, 174 can alternatively be arranged in other orders or other configurations within the scope of the present invention and can alternatively be buttons, menus, or other suitable means for displaying the desired information. The number of the record and the total number of records are indicated in the lower left corner of the layer as well as buttons for navigating through the records.

As shown in FIG. 19, the “Promotions” tab or layer 170 includes data fields or distinct data boxes 72 for entering and displaying specific information regarding promotions associated with a particular television station such as, for example, types of events, types of interviews, and types of products reviewed. The layer 170 also includes additional data fields 176 for entering and displaying the target audience of the television station and the lead time required for arranging a promotion. The target audience data field 176 preferably includes a pull down menu containing possible choices. The illustrated layer 170 further includes a data field 178 for miscellaneous notes regarding promotions at the particular television station. The name or company 180 of the television station associated with the currently displayed “Promotions” layer 170 is also included. The button field 80 as described here in above with regard to the “Artists” layer 34 of FIG. 2 is also provided. However, the call button 92 is eliminated.

As shown in FIG. 20, the “Programs” tab or layer 172 includes data fields or distinct data boxes 72 for entering and displaying specific information regarding programs associated with a particular television station such as, for example, the title of the program, the profile of the program, and the air day of the program. These data fields 72 preferably include pull down menus containing possible choices. The layer also includes additional data fields 142 for entering and displaying the on air and off air times for the program. The illustrated layer 172 further includes a data field 144 for miscellaneous notes regarding the program. The name or company 180 of the television station associated with the currently displayed program information is preferably displayed in the upper left corner of the layer. Additionally, the name or title 182 of the program is preferably displayed below the name 180 of the television station. The number of the record and the total number of records are indicated in the lower left corner of the layer as well as buttons for navigating through the records. The button field 80 as described hereinabove with regard to the “Artists” layer 34 of FIG. 2 is also provided. However, the call button 92 is eliminated.

As shown in FIG. 21, the “Studio Address” tab or layer 174 includes data fields or distinct data boxes 72 for entering and displaying specific information regarding the television studio where programs take place. Some of these data fields 72 can include pull down menus containing possible choices. The illustrated layer 174 also includes a data field 148 for driving directions to the television studio. The name or company 180 of the television station associated with the currently displayed studio address information is preferably displayed in the upper left corner of the layer. The button grouping 80 as described hereinabove with regard to the “Artists” layer 34 of FIG. 2 is also provided.

As shown in FIG. 22, the venues window 122 includes data fields or distinct data boxes 72 for entering and displaying specific information regarding a particular venue. Some data fields 72 such as “E-Mail” and “Web Site” data fields preferably display hyperlinks adapted to cooperate with suitable intranet and/or internet software. The window 122 also includes additional data fields 74 for entering and displaying the region (preferably, one of about nine geographic regions of the United States), the area of dominant influence (ADI) (preferably, one of about 210 major cities in the United States), category (in this case venue), and the format of the venue (preferably, one of about twelve types of music but is typically variety or left blank for venues). These additional data fields 74 preferably include pull down menus containing all possible choices. Information or data can be input for entering a new venue into the data base program 10 or displayed for showing a stored venue. The name or company 184 of the currently displayed venue is preferably displayed in the upper left corner of the window. The number of the record and the total number of records are indicated in the lower left corner of the window as well as buttons for navigating through the records.

The window 122 also includes the button grouping 80 such as that described hereinabove with regard to the “Artists Organization” window 34 of FIG. 2. Also included, however, are a “Contacts” button 126 and a “Profile button” 128 as discussed hereinabove and located below the first column of buttons and to the left of the call button 92. The “Contacts” button 126 is utilized to open the “Contacts” window 38 to display information for contact persons for the venue as described in more detail hereinbelow. The “Profile” button 128 is utilized to open a “Venue Profile” window 186.

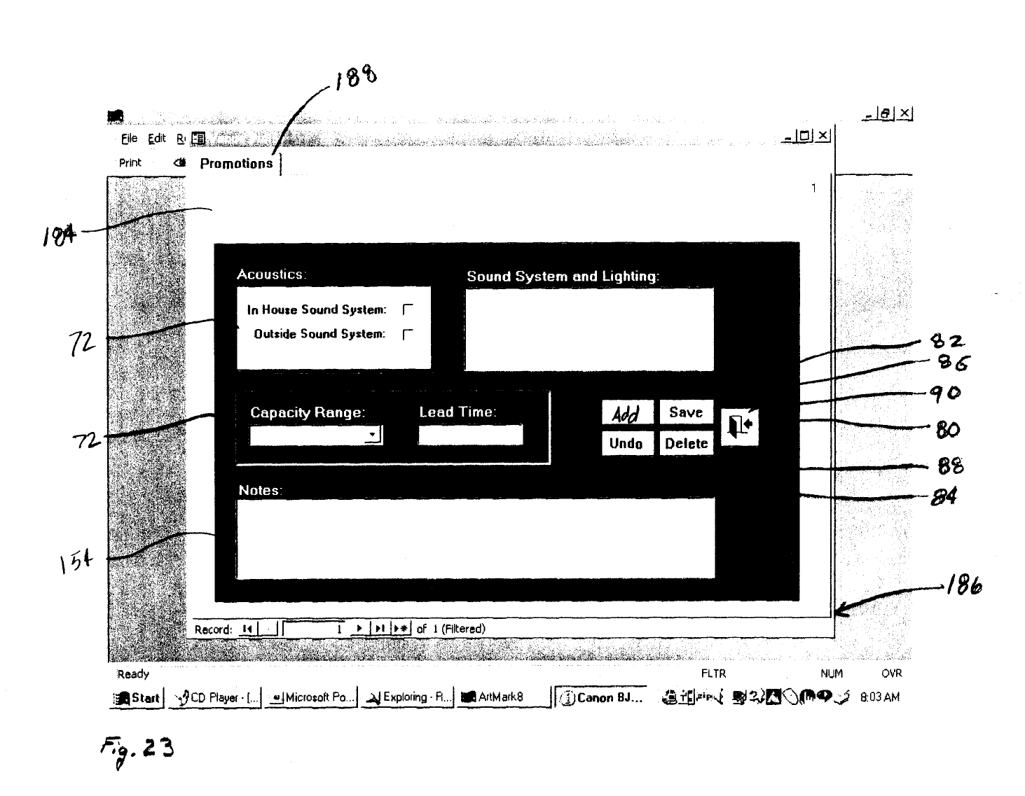

As best shown in FIG. 23, the “Venue Profile” window 186 includes a single “Promotions” tab 188 for displaying a layer of the window 186 (FIG. 23) to utilize information relating to promotions of a particular venue. It is noted that the “Venue Profile” window 186 can alternatively have a greater number of tabs 188 and/or can alternatively have a different tab 188 within the scope of the present invention. It is also noted that the tab 188 can alternatively be arranged in other configurations within the scope of the present invention and can alternatively be a button, menu, or other suitable means for displaying the desired information.

As shown in FIG. 23, the “Promotions” tab or layer 188 includes data fields or distinct data boxes for entering and displaying specific information regarding promotions associated with a particular venue such as, for example, acoustic information and sound system and lighting information. The illustrated layer 188 also includes data fields 72 for entering and displaying the capacity of the venue and the lead time for arranging a concert at the venue. The capacity data field 72 is preferably provided with a pull down menu of possible choices. The illustrated layer 188 further includes a data field 154 for miscellaneous notes regarding promotions at the particular venue. The name or company 184 of the venue associated with the currently displayed promotion information is preferably displayed in the upper left corner of the layer. The button field 80 as described hereinabove with regard to the “Artists” layer 34 of FIG. 2 is also provided. However, the call button 92 is eliminated.

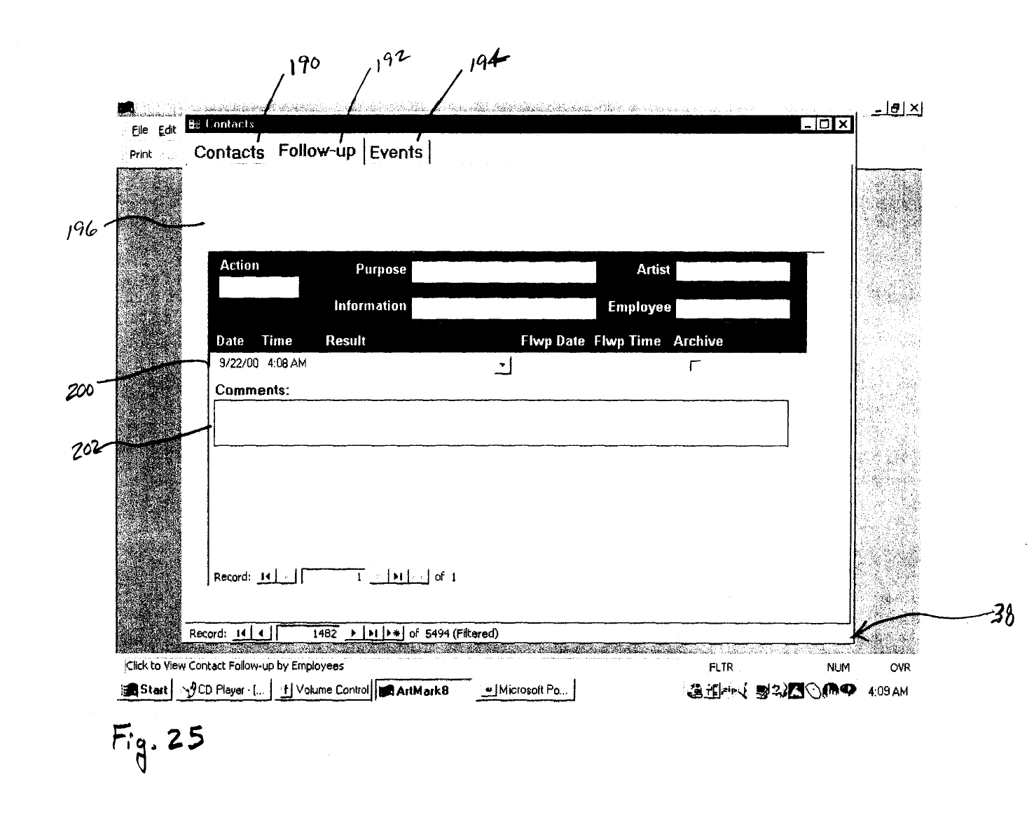

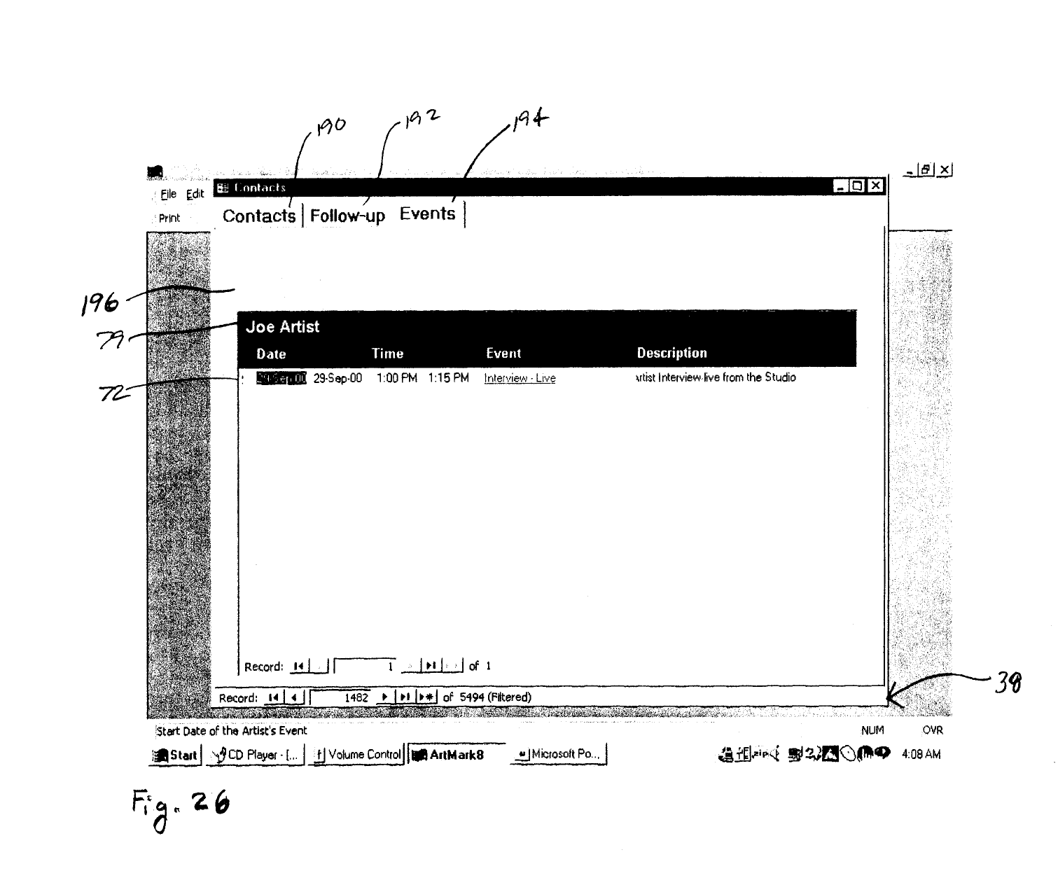

As best shown in FIG. 24, the “Contacts” window 38 includes the four buttons 106, 108, 110, 112 as described hereinabove with regard to the “Avenues” window 36 of FIG. 10. The window 38 also includes three tabs or layers 190, 192, 194, a “Contacts” tab 190 (FIG. 24) for recording and displaying information relating to a particular contact, a “Follow-Up” tab 192 (FIG. 25) for displaying information relating to needed follow-up actions with the particular contact, and an “Events” tab 194 (FIG. 26) for displaying particular events relating to the particular contact. The number of the record and the total number of records are indicated in the lower left corner of the window as well as buttons for navigating through the records.

The “Contacts” tab 190 includes data fields or distinct data boxes 72 for entering and displaying specific information regarding particular contacts at the companies identified in the avenues records. Some data fields 72 such as “E-Mail” and “Web Site” data fields preferably display hyperlinks adapted to cooperate with suitable intranet and/or internet software. The layer 190 also includes additional data fields 74 for entering and displaying the region (preferably, one of about nine geographic regions of the United States), the area of dominant influence (ADI) (preferably, one of about 210 major cities in the United States), category (such as radio, retail, media, or venue), and the format (one of about twelve types of music). These additional data fields 74 preferably include pull down menus containing all possible choices. Information or data can be input for entering a contact into the data base program or displayed for showing a stored contact. The name and title 196 of the currently displayed contact is preferably displayed in the upper left corner of the layer 190. The layer 190 also includes the button grouping 80 such as that described hereinabove with regard to the “Artists Organization” window 34 of FIG. 2. Also included, however are a “Schedule Event” button 198 located below the first and second columns of buttons and above of the call button 92. The “Schedule events” button 198 is utilized to open the “Events” window 40 as described in more detail hereinafter.

As shown in FIG. 25, the “Follow-Up” tab or layer 192 includes data fields or distinct data boxes 72 for entering and displaying specific information regarding needed follow-up actions with the particular contact such as, for example, whether to archive, types of action, purpose of action, information regarding action, the artist involved, and the name of the employee which is to take the action. The layer 192 also includes additional data fields 200 for entering and displaying the date, time and result, and the follow up date and time. The illustrated layer 192 further includes a data field 202 for miscellaneous comments regarding the follow-up action. The name and title 196 of the particular contact is preferably displayed in the upper left corner of the layer.

As shown in FIG. 26, the “Events” tab or layer 194 includes data fields or distinct data boxes 72 for displaying specific information regarding events associated with the particular contact and a particular artist such as, for example, the date of the event, the time of the event, the type of event, and a description of the event. The name and title of the particular contact 196 is preferably displayed in the upper left corner of the layer. Additionally, the name of the artist 79 associated with the event is displayed below the name and title of the contact.

As best shown in FIG. 27, the “Events” window 40 includes the four buttons 106, 108, 110, 112 as described hereinabove with regard to the “Avenues” window 36 of FIG. 10. The events window 40 also includes data fields or distinct data boxes 72 for entering and displaying specific information regarding particular events such as the name of the contact for the event, the artist associated with the event, the type of event, the start and end dates of the event, the start and end times of the event, a description of the event, and the location of the event. The window 40 also includes additional data fields 74 for entering and displaying the region (preferably, one of about nine geographic regions of the United States) and the area of dominant influence (ADI) (preferably, one of about 210 major cities in the United States). These additional data fields 74 preferably include pull down menus containing all possible choices. Information or data can be input for entering an event into the database program 10 or displayed for showing a stored event. The name 124 of the company associated with the currently displayed event is preferably displayed in the upper left corner of the window 40. The window 40 also includes the button grouping 80 such as that described hereinabove with regard to the “Artists Organization” window 34 of FIG. 2. However, the call button 92 is deleted. Also, a “View Calendar” button 204 is located below the first and second columns of buttons. The “View Calendar” button 204 utilized to open an “Artist Events” window 206 as described in more detail hereinafter.

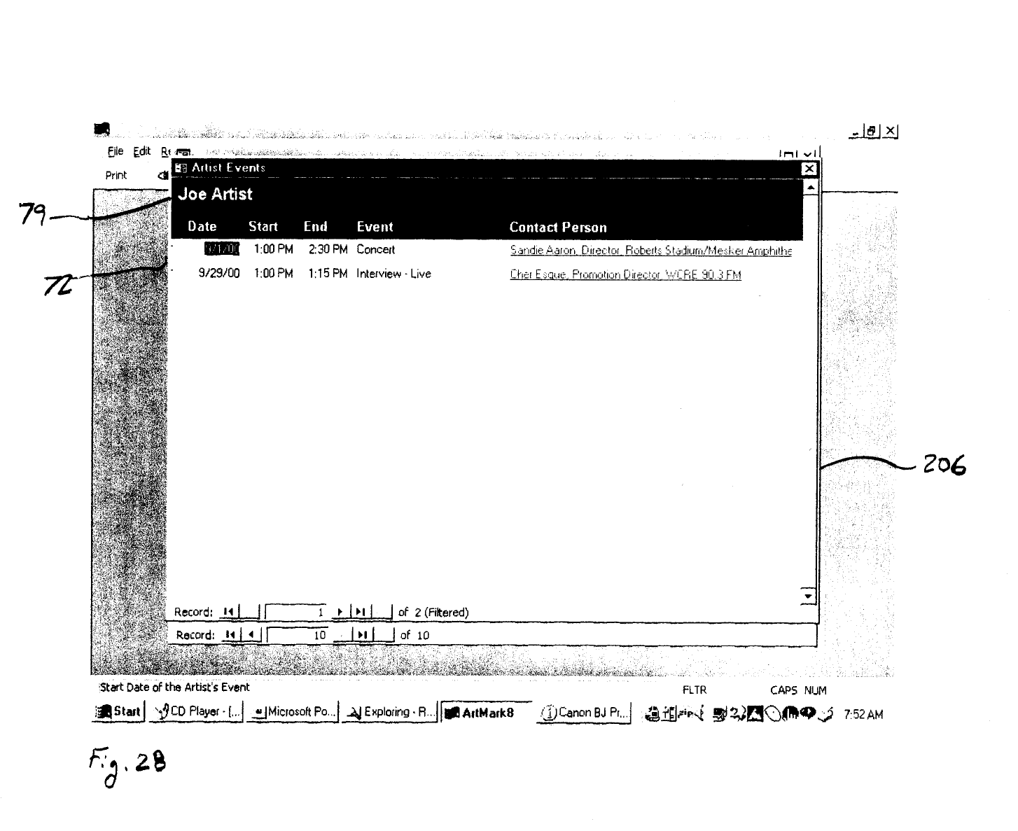

As shown in FIG. 28, the “Artist Events” window 206 includes data fields or data listing 72 displaying specific information regarding events for a particular artist such as the date of the event, the start and end times of the event, and the contact person associated with the event. The information regarding the contact person for the event preferably includes a hyperlink to the “Contacts” window 38 associated with that particular contact. The name 79 of the artist associated with the currently displayed list of events is preferably displayed in the upper left corner of the window.

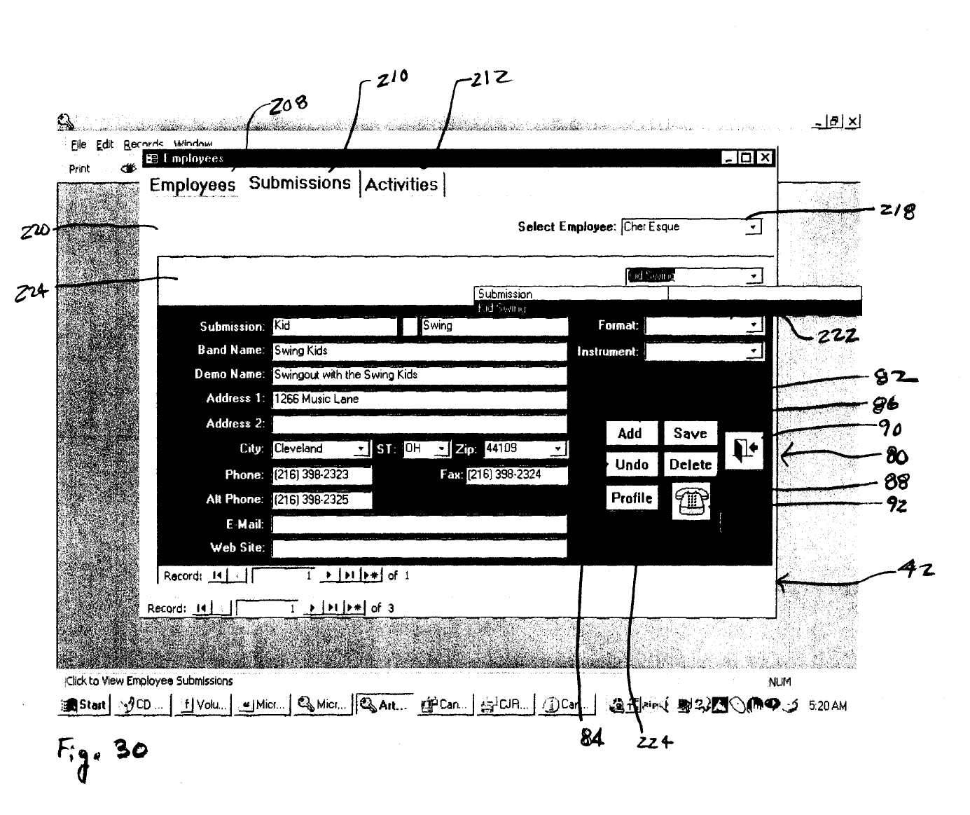

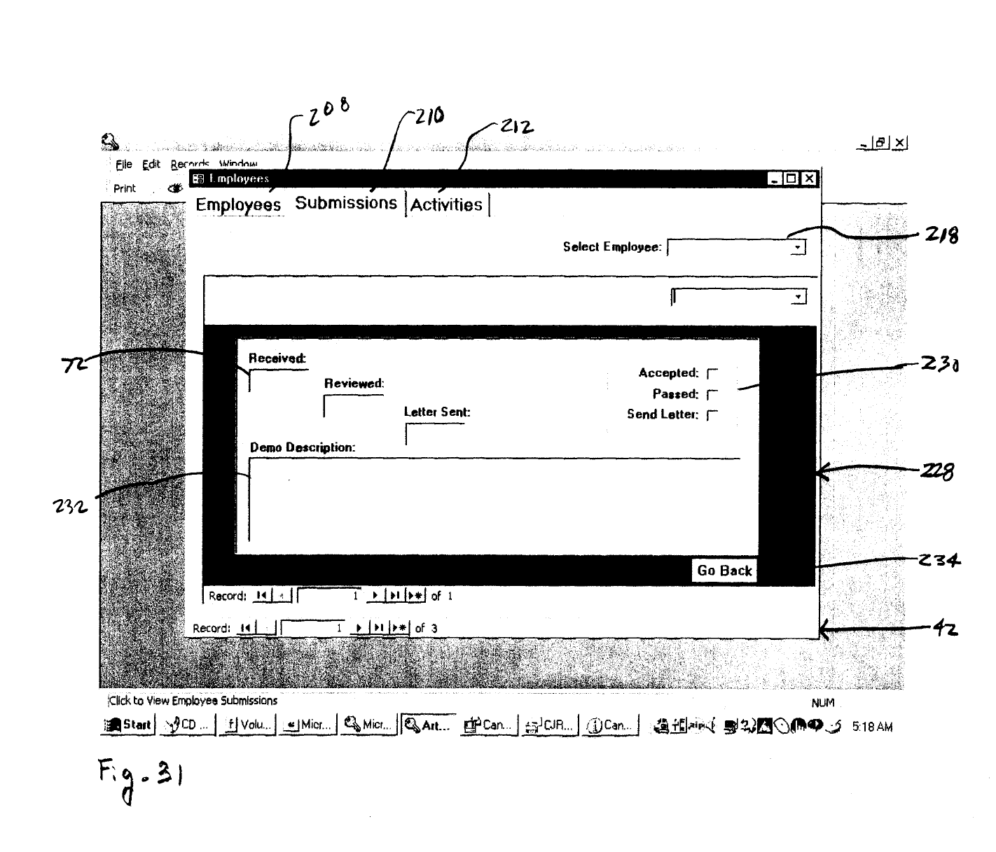

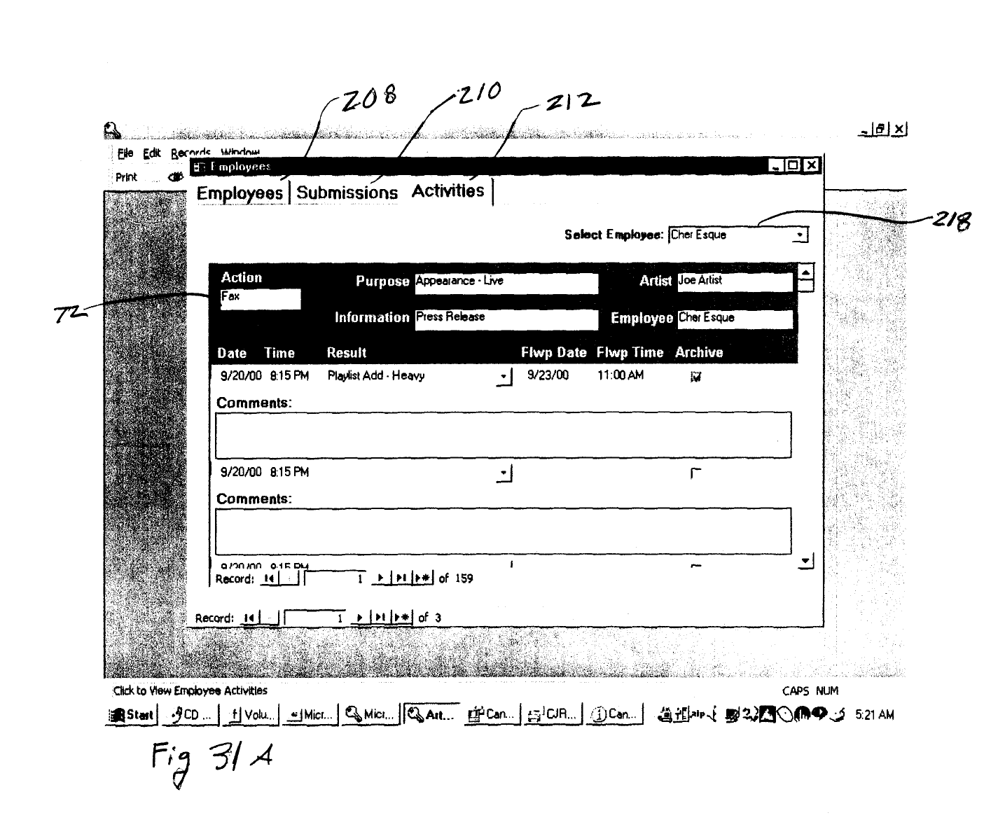

As best shown in FIG. 29, the “Employees” window 42 includes three tabs 208, 210, 212 including an “Employees” tab 208 for displaying a layer of the window 42 (FIG. 29) to utilize information relating to a particular employee of the company utilizing the database program 10, a “Submissions” tab 210 for displaying a layer of the window 42 (FIG. 30) to utilize information relating to submissions associated with a particular employee, and an “Activities” tab 212 (FIG. 31A) for displaying a layer of the window 42 (not shown) to display information relating to activities of a particular employee. It is noted that the “Employees” window 42 can alternatively have a fewer or greater number of tabs 208, 210, 212 and/or can alternatively have different tabs 208, 210, 212 within the scope of the present invention. It is also noted that the tabs 208, 210, 212 can alternatively be arranged in other orders or other configurations within the scope of the present invention and can alternatively be buttons, menus, or other suitable means for displaying the desired information.

As shown in FIG. 30, the “Employees” tab or layer 208 includes data fields or distinct data boxes 72 for entering and displaying specific contact information regarding a particular employee. Some data fields 72 such as “E-Mail” and “Web Site” data fields preferably display hyperlinks adapted to cooperate with suitable intranet and/or internet software. The layer 208 also includes additional data fields 214 for entering and displaying the type of company and the department of the employee. These additional data fields 214 preferably include pull down menus containing all possible choices. The illustrated layer 208 further includes a data field 216 for indicating the social security number of the employee. Information or data can be input for entering a new employee into the data base program or displayed for showing a stored employee. Information relating to a stored employee can be retrieved by indicating the stored employee in the “Select Employee” field 218 which preferably includes a pull down menu containing all stored employees. The name 220 of the company of the currently displayed employee is preferably displayed in the upper left corner of the layer 208. The number of the record and the total number of records are indicated in the lower left corner of the window as well as buttons for navigating through the records. The button grouping 80 as described hereinabove with regard to the “Artists” layer 34 of FIG. 2 is also provided.

As shown in FIG. 30, the “Submissions” tab or layer 210 includes data fields or distinct data boxes 72 for entering and displaying specific contact information regarding submissions made by a particular artist such as, for example, submission name, artist name, demo name and contact information. Some data fields 72 such as “E-Mail” and “Web Site” data fields preferably display hyperlinks adapted to cooperate with suitable intranet and/or internet software. The layer 210 also includes additional data fields 222 for entering and displaying the format and instrument of the submission. These additional data fields 222 preferably include pull down menus containing all possible choices. Information or data can be input for entering a new submission into the data base program or displayed for showing a stored submission. Information related to stored submissions associated with a particular employees can be retrieved by indicated the employee in the “Select Employee” field 218 which preferably includes a pull down menu containing all stored employees. The name 220 for the employee's company associated with the currently displayed submission is preferably displayed in the upper left corner of the layer 210. Additionally, the title 224 of the currently displayed submission is displayed below the name of the company. The number of the record and the total number of records are indicated in the lower left corner of the layer as well as buttons for navigating through the records. The button grouping 80 as described hereinabove with regard to the “Artists” layer 34 of FIG. 2 is also provided. Additionally, a “Profile” button 226 is located below the first column of buttons. The “Profile” button 226 is used to open a “Submissions Profile” window 228.

As best shown in FIG. 31, the “Submissions Profile” window 228 includes data fields or distinct data boxes 72 for entering and displaying specific information regarding the particular submission such as, for example, date received, date reviewed, and date letter sent. Also included are data fields 230 for indicating whether the submission was accepted passed or letter sent. The illustrated window 228 includes a data field 232 for a description of the demo submitted. The illustrated window 228 also includes a “Go Back” button 234 which returns the display to the “Submissions” tab 210 of FIG. 30. The number of the record and the total number of records are indicated in the lower left corner of the layer as well as buttons for navigating through the records.

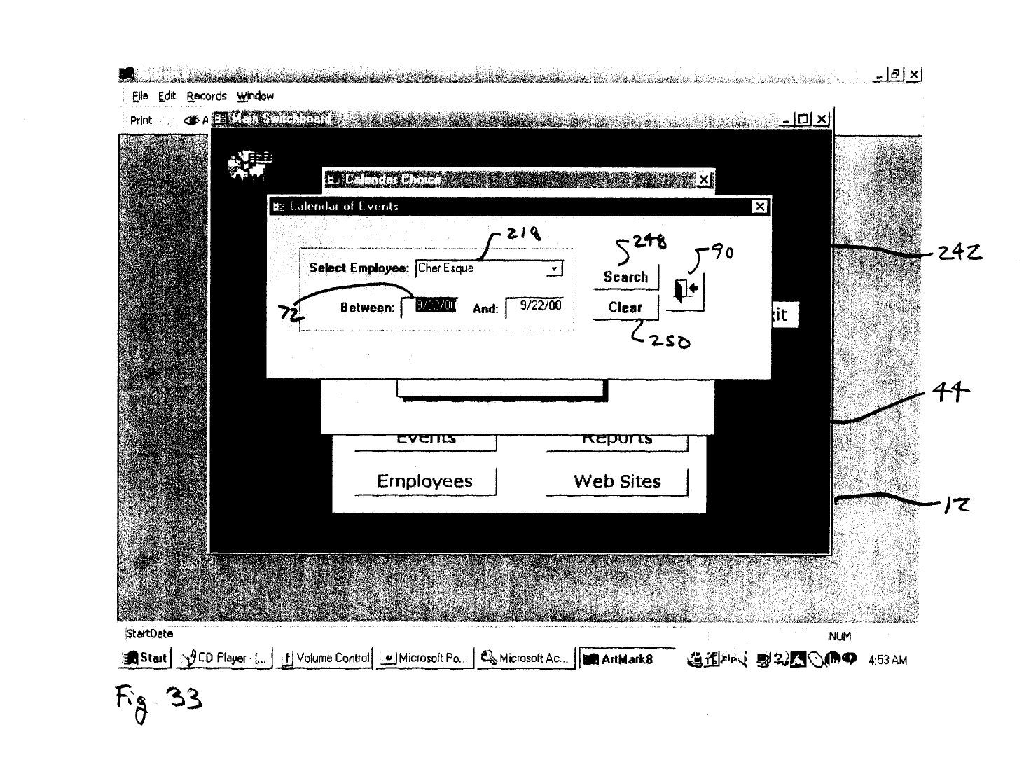

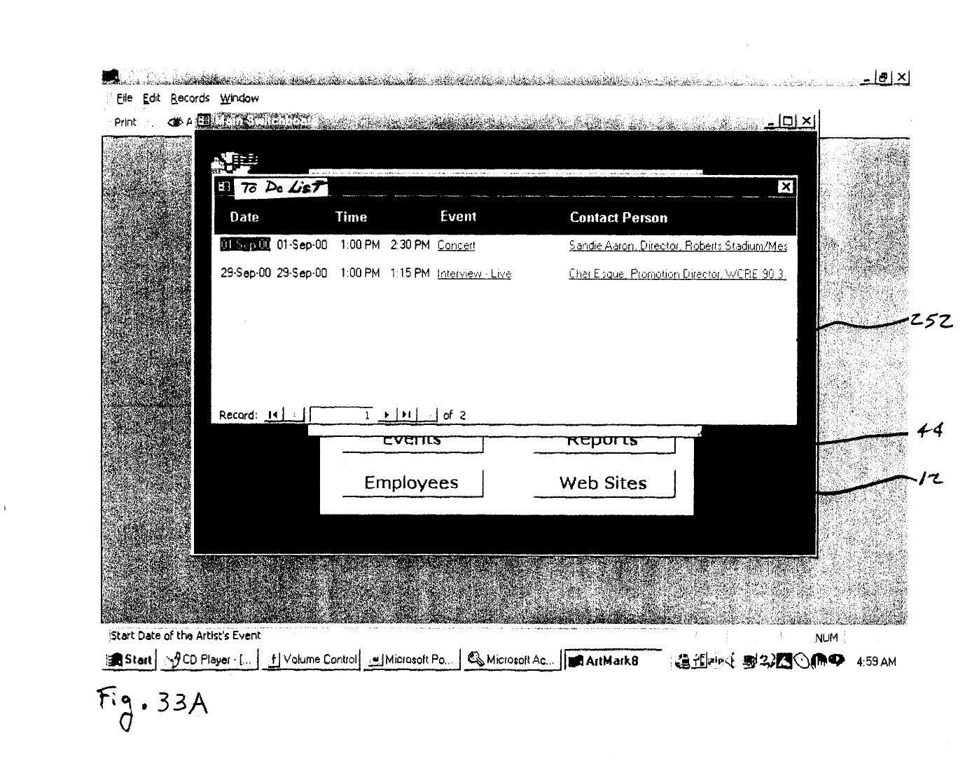

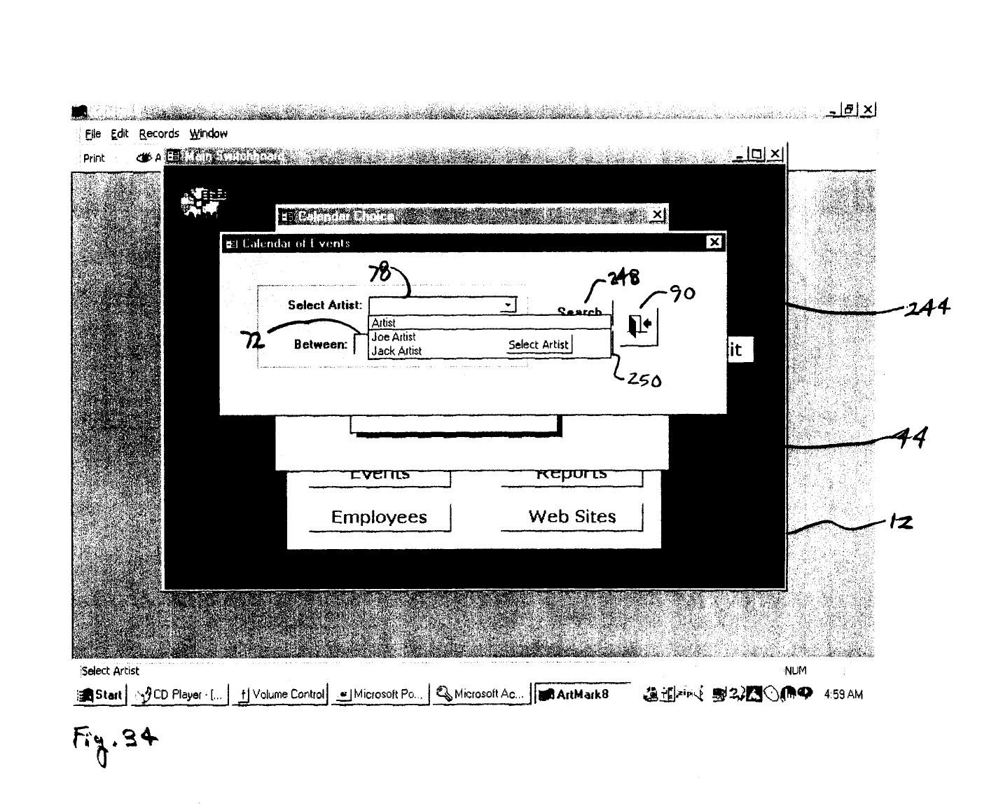

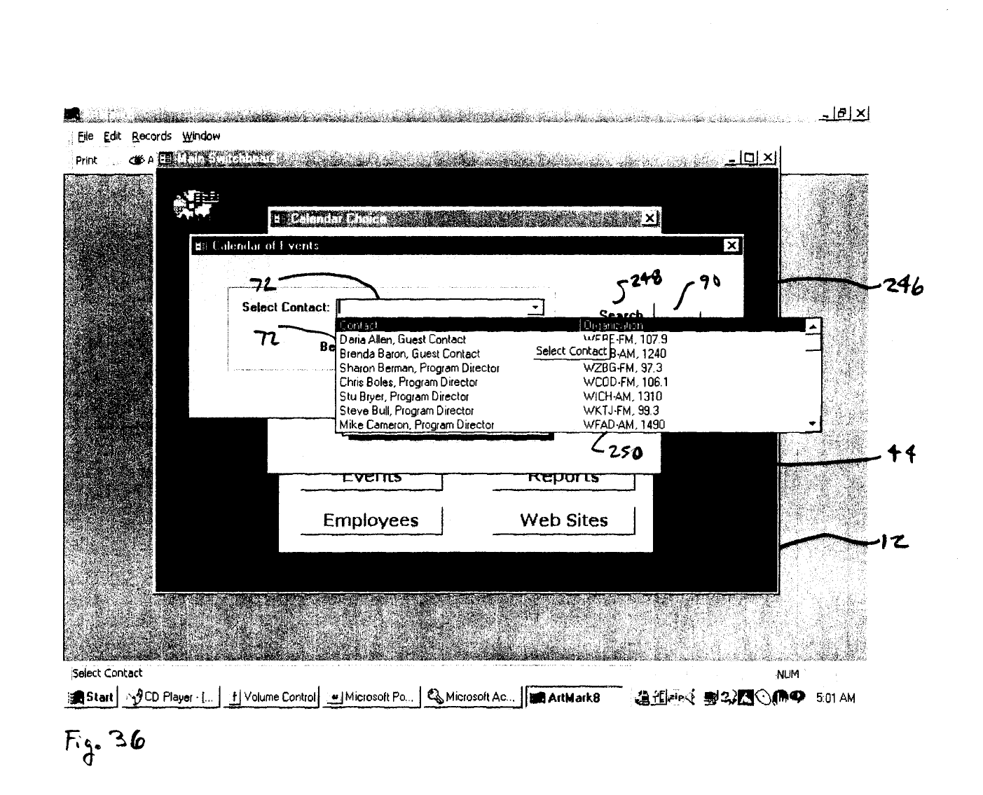

As best shown in FIG. 32, the “Calendar Choice” window 44 includes a main portion having a column of three buttons 236, 238, 240, each button for opening a desired window to obtain a desired calendar. The buttons 236, 238, 240, in descending order, include an “To Do List” button 236 for opening an “Calendar of Events” window 242 (FIG. 33) to utilize information relating to particular employees, an “Artist Schedule” button 238 for opening an “Calendar of Events” window 244 (FIG. 34) to utilize information relating to various artists, and a “Contact History” button 240 for opening a “Calendar of Events” window 246 (FIG. 36) to utilize information relating to contacts. It is noted that the “Calendar Choice” window 44 can alternatively have a fewer or greater number of buttons 236, 238, 240 and can alternatively have different buttons 236, 238, 240 within the scope of the present invention. It is also noted that the buttons 236, 238, 240 can alternatively be arranged in other orders or other configurations within the scope of the present invention.

As best shown in FIG. 33, the “To Do List” button 236 opens a “Calendar of Events” window 242 which includes data fields or distinct data boxes 72 for entering information regarding a particular employee such as, for example, the name of the employee and start and end dates for the calendar of events. Preferably, the name of the employee is selected by a pull down menu containing all stored employees. The “Calendar of Events” window 242 also includes a grouping of buttons 248, 250, 90 located to the right of the data fields 72. The illustrated button grouping includes a “Search” button 248, a “Clear” button 250, and a close button 90 illustrating a closing door as described hereinabove. The “Search” button 248 locates records within the indicated parameters and displays all the stored actions or tasks for a particular employee. The “Clear” button 250 removes the displayed data in the display. The close button 90 closes the “Calendar of Events” window 242. The “Search” button 248 initiates the creation of a listing of events associated with a particular employee as shown in FIG. 33A.

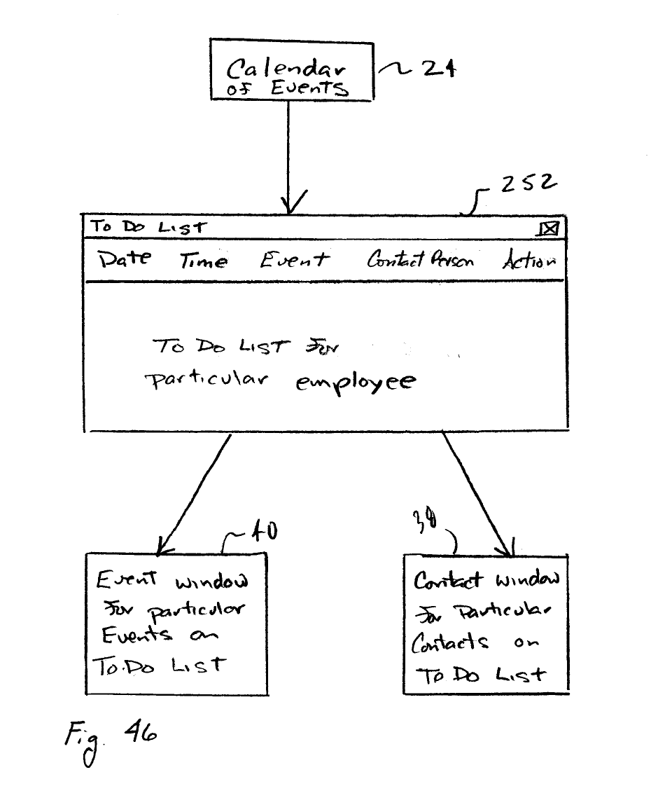

As best shown in FIG. 46, the “to do list or task list for a particular employee is linked to relevant event windows 40 associated with particular events on the task list or to do list and relevant contact windows 38 associated with particular events on the task list. Thus, the employee can easily generate a to do list for themselves or another particular employee for a specified period of time and then by clicking on the links can view information related to the items on the task list. This enables employees to quickly and efficiently perform their task by having easy and quick access to information related to their task.

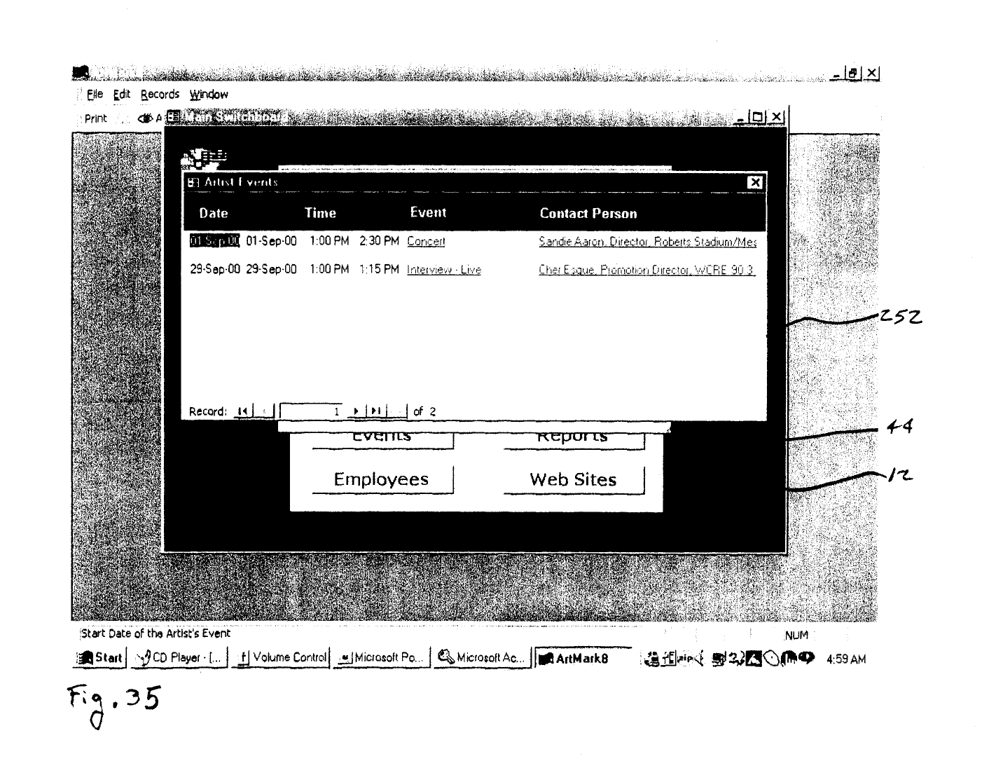

As best shown in FIG. 34, the “Artist Schedule” button 238 opens a “Calendar of Events” window 244 which includes data fields or distinct data boxes 72 or entering information regarding a particular artist such as, for example, the name of the artist and start and end dates for the calendar of events. Preferably, the name of the artist is selected by a pull down menu containing all stored artists. The “Calendar of Events” window 238 also includes a grouping of buttons 248, 250, 90 located to the right of the data fields 72 as described hereinabove with regard to FIG. 33. FIG. 35 illustrates one embodiment of the Artist event calendar 252 obtained by the “Search” button 248. The event and contact information preferably includes hyperlinks to the associated “Event” and “Contacts” windows 38, 40 as described hereinabove.

As best shown in FIG. 36, the “Contact History” button 240 opens a “Calendar of Events” window 246 which includes data fields or distinct data boxes 72 for entering information regarding a particular contact such as, for example, the name of the contact and start and end dates for the desired calendar of events. Preferably, the name of the contact is selected by a pull down menu containing all stored contacts. The “Calendar of Events” window 246 also includes a grouping of buttons 248, 250, 90 located to the right of the data fields 72 as described hereinabove with regard to FIG. 33. The “Search” button 248 initiates the creation of a listing of events associated with a particular contact similar to the listing FIG. 35 but listing all events for a particular contact instead of all events for a particular artist. The event and artist information preferably includes hyperlinks to the associated “Events” and “Artists” windows 40, 34 as described hereinabove.

As best shown in FIG. 37, the “Search And Apply” window 46 includes the four buttons 106, 108, 110, 112 as described hereinabove with regard to the “Avenues” window 34 of FIG. 10. When the “Radio” button 106 is selected, the window 46 also includes data fields or distinct data boxes 72, 74 for entering specific information regarding parameters for a search of stored data such as, for example, a company name, a contact name, a contact title, a format, a target audience, a program type, program air day, and region. In the illustrated window 46, some of these data fields 72, 74 include pull down menus containing all possible choices. The illustrated window 46 also includes the button grouping as described hereinabove with regard to the “Calendar of Events” window 242 of FIG. 33, however the grouping additionally includes an “Update” button 254 and a “Print” button 256. The “Update” button 254 opens an “Update Your Contact History” window 258. Similar windows are displayed when the “Retail”, “Media” and “Venues” buttons 108, 110, 112 are selected except that the data fields 72, 74 are adjusted as desired.

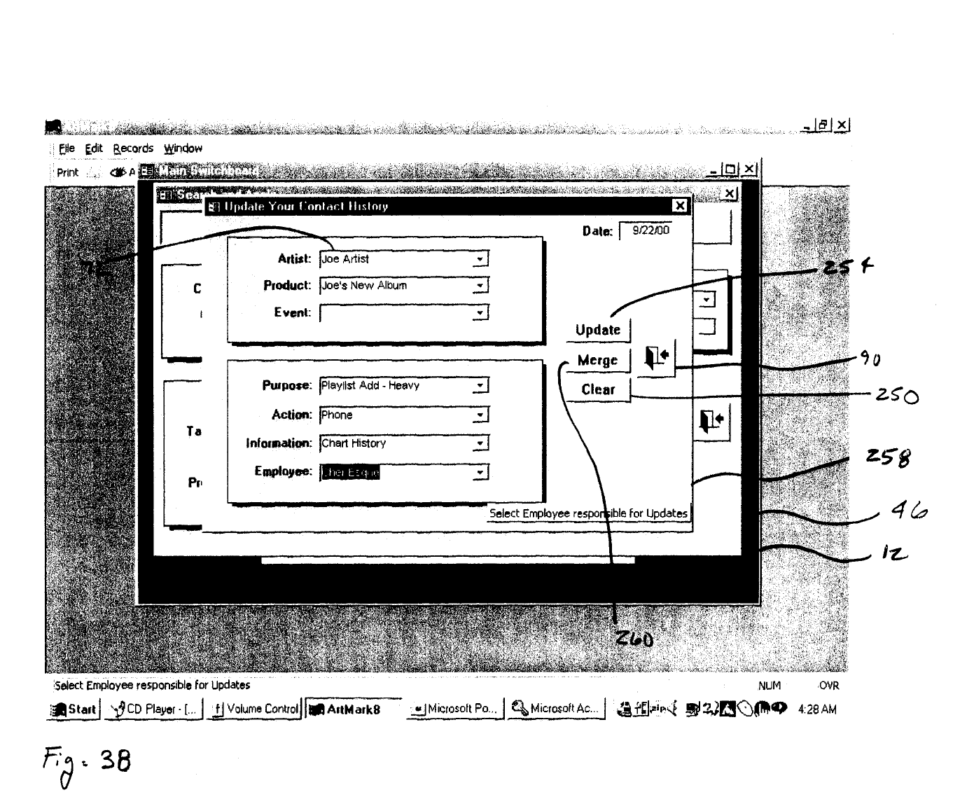

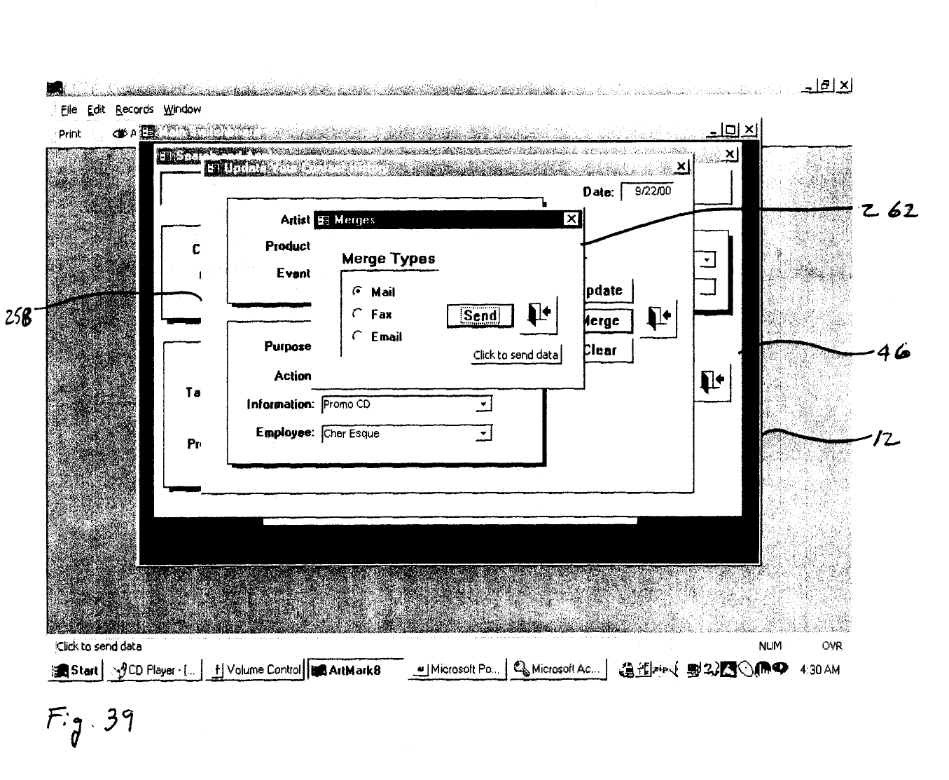

As best shown in FIG. 38, the “Update Your Contact History” window 258 includes data fields or distinct data boxes 72 for information to be included or added into the stored contact history, such as for example, the name of the artist, the name of the product, the name of the event, the purpose of the contact, the type of action, the information conveyed by the contact, and the employee responsible. The illustrated window 258 includes pull down menus containing all stored choices. Also included is a button grouping located to the right of the data fields 72. The button grouping includes an “Update” button 254, a “Merge” button 260, a “Clear” button 250, and close button 90. The “Merge” button 260 opens a “Merges” window 262 (FIG. 39) from which a desired type of merge for the data is selected. The “Merges” window 262 includes a “Send” button.

As best shown in FIG. 41, the “Archives” window 48 includes a main portion 268 adapted for selecting an archive type such as, for example, artists, contacts, or submissions. The “Archives” window 48 also has a column of three buttons 270, 272, 274, each button for performing a desired function. The buttons 270, 272, 274, in descending order, include an “Store” button 270 for storing desired information in archives (that is, out of the active database records), a “Retrieve” button 272 for retrieving desired information from the archives, and a “Delete” button 274 for deleting desired information from the archives. The window 48 also includes a close button 90 for closing the “Archives” window 48. It is noted that the “Archives” window 48 can alternatively have a fewer or greater number of buttons 270, 272, 274 and can alternatively have different buttons 270, 272, 274 within the scope of the present invention. It is also noted that the buttons 270, 272, 274 can alternatively be arranged in other orders or other configurations within the scope of the present invention.

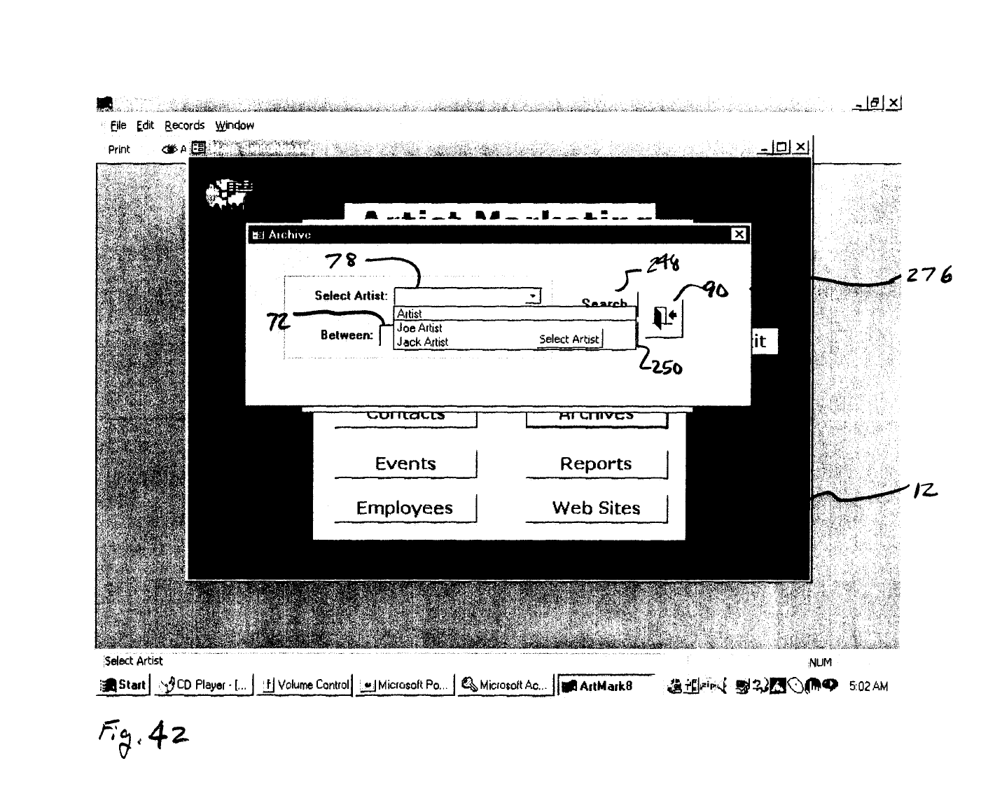

FIG. 42 illustrates the archive window 276 opened when an artist type archive is selected. The window 276 includes data fields or distinct data boxes 72, 78 for data describing the data located such as, for example, the artist name and the beginning and ending dates for the information. The artist name data field 78 preferably has a pull down menu of the stored artists. The window 276 also includes a button grouping as described hereinabove with reference to FIG. 33. Similar archive windows are opened when a contact or submission type archive is selected but the contact or submission name is required instead of the artist name.

As best shown in FIG. 43, the “Reports” window 50 includes a main portion 278 adapted for selecting a report type such as, for example, labels, letters, lists, charts/graphs, or summaries. The “Reports” window 50 also has a grouping of three buttons 280, 282, 290, each button for performing a desired task. The buttons include a “Preview” button 280 for previewing the desired report on the display, a “Print” button 282 for printing the desired report, and a close button 90 for closing the “Reports” window 50.

As best shown in FIG. 44, the “Web Sites” window 52 includes data fields or distinct data boxes 72 for information relating to stored web sites, such as, for example, a company name, a web page address associated with the company, and a purpose or note. The web page data field 72 preferably displays a hyperlink adapted to cooperate with suitable intranet and/or internet software. The “Web site” window 52 also has a button grouping as described hereinabove with regard to the “Artist Organization” window 34 of FIG. 2. However, the call button 92 is eliminated.

It is apparent from the above description that the software and method according to the present invention provides a tool for storing a large amount of data relating to marketing an artist, searching for and displaying desired stored data in a plurality of different manners with a plurality of different search criteria or parameters, analyzing past actions taken with regard to marketing artists, and planning future actions to be taken to market artists. Additionally, it is apparent that sales figures can be easily matched against marketing efforts and profiles can be obtained for each avenue of marketing so that future tasks can be successfully planned. Moreover, it is apparent that a company wide “To Do List” and a company wide “Contact History” are obtained to further reduce human expenditures.

From the foregoing disclosure and detailed description of certain preferred embodiments, it will be apparent that various modifications, additions and other alternative embodiments are possible without departing from the true scope and spirit of the present invention. For example, it will be apparent to those skilled in the art, given the benefit of the present disclosure, that the various windows, tabs, and buttons can have many different shapes and locations and associated information. The embodiments discussed were chosen and described to provide the best illustration of the principles of the present invention and its practical application to thereby enable one of ordinary skill in the art to utilize the invention in various embodiments and with various modifications as are suited to the particular use contemplated. All such modifications and variations are within the scope of the present invention as determined by the appended claims when interpreted in accordance with the benefit to which they are fairly, legally, and equitably entitled.

What is claimed is:

1. A software product for internally organizing marketing tasks and related information within a business entity, the software product comprising:
a computer program operational when executed by a computer processor to direct the computer processor to generate a main navigational window viewable on a computer display and having a plurality of links;
wherein the computer program is operational when executed by the computer processor upon activation of the plurality of links to direct the computer processor to generate additional windows viewable on the computer display;
wherein the plurality of links includes a marketed entities link, an avenues link, a contacts link, and an events link;
wherein the marketed entities link opens a marketed entities window having data fields for entering and viewing contact data relating to particular individuals of particular marketed entities;
wherein the avenues link opens an avenue window having data fields for entering and viewing contact data relating to particular individuals at different avenues of marketing used for marketing the particular marketed entities;
wherein the contacts link opens a contact window having data fields for entering and viewing contact data relating to a particular individual;
wherein the events link opens an event window having data fields for entering and viewing contact data relating to particular individuals associated with particular events used for marketing the particular marketed entities;
a to-do list window displays stored actions associated with a particular person within the business entity and has links to particular event windows related to the stored actions and to particular contact windows related to the stored actions; and
a computer program storage medium operational to store the computer program.

2. The software product according to claim 1, wherein the to-do list window displays stored actions associated with an employee of the business entity.

3. The software product according to claim 1, wherein data fields are provided for entering and displaying information regarding a particular person in order to generate the to-do list window displaying stored actions associated with that particular person.

4. The software product according to claim 3, wherein the calendar of events window includes data fields for entering information regarding an employee of the business entity.

5. The software product according to claim 4, wherein the calendar of events window includes a pull down menu for selecting an employee from a list of employees of the business entity.

6. The software product according to claim 1, wherein data fields are provided for entering and displaying a period of time for stored actions to be displayed on the to-do list window.

7. The software product according to claim 1, wherein the links to particular event windows related to the stored actions open contact windows having contact data for contact persons associated with the stores actions.

8. The software product according to claim 1, wherein the links to particular contact windows related to the stored actions open contact windows having contact data for contact persons associated with the stores actions.

9. The software product according to claim 1, wherein data fields are provided for entering and displaying information regarding a follow-up action with a particular contact.

10. The software product according to claim 9, wherein the follow up action with a particular contact is associated with an employee of the business entity.

11. The software product according to claim 1, wherein the events window includes data fields for entering and displaying information regarding a geographic region in the United States and an area of dominant influence associated with the particular events.

12. The software product according to claim 1, wherein the area of dominant influence is selected from about 210 major cities in the United States.

13. The software product according to claim 1, wherein data fields are provided for entering and displaying miscellaneous notes regarding particular contacts and particular stored actions.

14. The software product according to claim 1, further comprising an employees window having data fields for entering and displaying information regarding employees of the business entity.

15. The software product according to claim 14, wherein the events window includes data fields for entering and displaying information regarding submissions associated with a particular employee of the business entity.

16. The software product according to claim 15, wherein data fields are provided for entering and displaying information regarding particular submissions including, date received, date reviewed, and date letter sent.

17. The software product according to claim 14, wherein the events window includes data fields for entering and displaying information regarding activities associated with a particular employee of the business entity.

18. The software product according to claim 1, further comprising a calendar choice window having links to a calendar of events window to generate the to do list, a calendar of events window to generate a list of events associated with a particular marketed entity, and a calendar of events window for generating a list of prior contacts with a particular contact.

19. A method for internally organizing marketing tasks and related information within a business entity, the method comprising the steps of:
generating a main navigational window viewable on a computer display that has a plurality of links;
generating additional windows viewable on the computer display upon activation of the plurality of links;
wherein the plurality of links includes a marketed entities link, an avenues link, a contacts link, and an events link;
opening a marketed entities window having data fields for entering and viewing contact data relating to particular individuals of particular marketed entities upon activation of the marketed entities link;
opening an avenue window having data fields for entering and viewing contact data relating to particular individuals at different avenues of marketing used for marketing the particular marketed entities upon activation of the avenues link;
opening a contact window having data fields for entering and viewing contact data relating to a particular individual upon activation of the contacts link;
opening an event window having data fields for entering and viewing contact data relating to particular individuals associated with particular events used for marketing the particular marketed entities upon activation of the events link; and
displaying a to-do list window having stored actions associated with a particular person within the business entity and links to particular event windows related to the stored actions and to particular contact windows related to the stored actions.

20. A method for internally organizing marketing tasks and related information within a business entity, the method comprising the steps of:
(a) determining business rules of the business entity;
creating a software product having functions and procedures based on the business rules; and
wherein the software product can display a to-do list having stored actions associated with a particular person within the business entity and links to contact data for particular individuals related to the stored actions.
